(19) United States
(12) Patent Application Publication
(10) Pub. No.: US 2024/0216880 A1
(43) Pub. Date: Jul. 4, 2024

(54) SYSTEMS AND METHODS FOR MIXING

(71) Applicant: Rivian IP Holdings, LLC, Plymouth, MI (US)

(72) Inventors: Divyank Sood, Union City, CA (US); Ki Tae Park, Santa Clara, CA (US); Johnson Mark, San Jose, CA (US)

(21) Appl. No.: 18/147,859

(22) Filed: Dec. 29, 2022

(51) Int. Cl. B01F 29/83; B01F 29/00; B01F 35/32; B01F 35/92; H01M 4/04

(52) U.S. Cl. CPC B01F 29/83; B01F 29/40221; B01F 35/3214; B01F 35/3231; B01F 35/92; H01M 4/0404

(57) ABSTRACT

Systems and methods for mixing are disclosed. A system for mixing can include a mixer vessel that defines a chamber. The system can include a first mixing blade to cause a first rotational movement to mix a material within the chamber. The system can include a second mixing blade to cause a second rotational movement to mix the material within the chamber of the mixer vessel. The system can include a mixing element to cause a third rotational movement to mix the material within the chamber of the mixer vessel. The system can include the first mixing blade to cause the first rotational movement independent from at least one of the second rotational movement and the third rotational movement.

### INTRODUCTION

A mixing system or mixer can be used to mix materials, such as materials used for producing a battery. A battery can be used to operate a vehicle or components thereof.

### SUMMARY

A mixing system or mixer can be a variable shear mixing system to mix a material, such as an electrode material or a battery active material, which can be used to manufacture an electrode. The mixing system can include at least one mixer vessel defining a chamber, at least one mixing blade, and at least one mixing element. For example, the mixer can include two mixing blades and one mixing element to mix a material within the chamber. The mixing blade can include at least one blade tip, such as a high shear tip or some other tip to create shearing forces as the mixing blade mixes the material within the chamber. The mixing blade can extend into the chamber. The mixing element can be or include an inner vessel to rotate within the mixing vessel (e.g., within an outer vessel of the mixing vessel). For example, the chamber can be within the inner vessel, and the inner vessel can rotate relative to a stationary outer vessel. The mixing element can be or include at least one baffle to rotate within the chamber. For example, the baffle can extend into the chamber. The baffle can be angled relative to an inner wall of the chamber. The mixing blade and mixing element can rotate independently from each other to mix the material. For example, the mixing system can include a first mixing blade to rotate with a first rotational movement, a second mixing blade to rotate with a second rotational movement, and the mixing element to rotate with a third rotational movement. The first rotational movement of the first mixing blade can be independent from one or more of the second rotational movement and the third rotational movement. The mixing system can create high shear mixing zones within the chamber to effectively mix a material within the chamber. For example, the mixing system can create at least one high shear mixing zone, at least one medium shear mixing zone, and at least one low shear mixing zone to mix (e.g., blend, disperse, knead, homogenize, dilute, or otherwise mix) the material within the chamber. The mixing system can create a homogenous or substantially homogenous (e.g., greater than 80% homogenized, greater than 90% homogenized, greater than 95% homogenized, greater than 98% homogenized, or some other degree of homogeneity) mixture within the chamber in a short amount of time because multiple mixing blades and a mixing element can be simultaneously used. The mixing blades and the mixing element can be controlled (e.g., rotated, operated, manipulated) independently. For example, each mixing blade and each mixing element can be controlled separately from other mixing blades or mixing elements.

At least one aspect is directed to a system. The system can be a system for mixing. The system can include a mixer vessel defining a chamber. The system for mixing can include a mixer vessel that defines a chamber. The system can include a first mixing blade to cause a first rotational movement to mix a material within the chamber. The system can include a second mixing blade to cause a second rotational movement to mix the material within the chamber of the mixer vessel. The system can include a mixing element to cause a third rotational movement to mix the material within the chamber of the mixer vessel. The system can include the first mixing blade to cause the first rotational movement independent from at least one of the second rotational movement and the third rotational movement.

At least one aspect is directed to a method. The method can be a method of mixing. The method can include adding a material to a chamber of a mixer vessel. The method can include rotating a first mixing blade extending into the chamber of the mixer vessel for mixing the material within the chamber. The method can include rotating a second mixing blade extending into the chamber of the mixer vessel for mixing the material within the chamber. The method can include rotating a mixing element for mixing the material within the chamber. A first rotational movement of the first mixing blade can be independent from at least one of a second rotational movement of the second mixing blade and a third rotational movement of the mixing element.

At least one aspect is directed to a method. The method can be a method of manufacturing an electrode. The method can include adding an electrode material to a chamber of a mixer vessel. The method can include rotating a first mixing blade extending into the chamber of the mixer vessel for mixing the electrode material within the chamber. The method can include rotating a second mixing blade extending into the chamber of the mixer vessel for mixing the electrode material within the chamber. The method can include rotating a mixing element for mixing the electrode material within the chamber. A first rotational movement of the first mixing blade can be independent from at least one of a second rotational movement of the second mixing blade and a third rotational movement of the mixing element. The method can include applying the mixed electrode material to a current collector material.

At least one aspect is directed to a method. The method can be a method of providing a system for mixing. The system can include a mixer vessel defining a chamber. The system for mixing can include a mixer vessel that defines a chamber. The system can include a first mixing blade to cause a first rotational movement to mix a material within the chamber. The system can include a second mixing blade to cause a second rotational movement to mix the material within the chamber of the mixer vessel. The system can include a mixing element to cause a third rotational movement to mix the material within the chamber of the mixer vessel. The system can include the first mixing blade to cause the first rotational movement independent from at least one of the second rotational movement and the third rotational movement.

At least one aspect is directed to a method. The method can be a method of providing an electrode. The electrode can be an electrode manufactured by a method of manufacturing an electrode. The method can include adding an electrode material to a chamber of a mixer vessel. The method can include rotating a first mixing blade extending into the chamber of the mixer vessel for mixing the electrode material within the chamber. The method can include rotating a second mixing blade extending into the chamber of the mixer vessel for mixing the electrode material within the chamber. The method can include rotating a mixing element for mixing the electrode material within the chamber. A first rotational movement of the first mixing blade can be independent from at least one of a second rotational movement of the second mixing blade and a third rotational movement of the mixing element. The method can include applying the mixed electrode material to a current collector material.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example mixing system, in accordance with some aspects.

FIG. 2 depicts an example mixing system, in accordance with some aspects.

FIG. 3 depicts an example mixing system, in accordance with some aspects.

FIG. 4 depicts a cross-sectional view of an example mixer vessel, gear box, and mixing blade of an example mixing system, in accordance with some aspects.

FIG. 5 depicts example shear zones created by a mixing system including a baffle, in accordance with some aspects.

FIG. 6 depicts example shear zones created by a mixing system including a rotating inner vessel, in accordance with some aspects.

FIG. 7 depicts an example mixer blade, in accordance with some aspects.

FIG. 8 depicts an example mixer blade, in accordance with some aspects.

FIG. 9 depicts an example mixer blade, in accordance with some aspects.

FIG. 10 depicts an example mixer blade, in accordance with some aspects.

FIG. 11 depicts an example mixer blade, in accordance with some aspects.

FIG. 12 depicts an example mixer blade, in accordance with some aspects.

FIG. 13 depicts an example mixer blade, in accordance with some aspects.

FIG. 14 depicts an example mixer blade, in accordance with some aspects.

FIG. 15 depicts an example mixer blade, in accordance with some aspects.

FIG. 16 depicts an example mixer blade, in accordance with some aspects.

FIG. 17 depicts an example mixer blade, in accordance with some aspects.

FIG. 18 is a flow chart of an example method of mixing, in accordance with some aspects.

FIG. 19 depicts an example electric vehicle, in accordance with some aspects.

FIG. 20 depicts an example battery pack, in accordance with some aspects.

FIG. 21 depicts an example battery module, in accordance with some aspects.

FIG. 22 depicts a cross sectional view of an example battery cell, in accordance with some aspects.

FIG. 23 depicts a cross sectional view of an example battery cell, in accordance with some aspects

FIG. 24 depicts a cross sectional view of an example battery cell, in accordance with some aspects.

FIG. 25 is a block diagram illustrating an architecture for an example computer system that can be employed to implement elements of the systems and methods described and illustrated herein.

FIG. 26 is a flow chart of an example method of providing a mixing system, in accordance with some aspects.

FIG. 27 is a flow chart of an example method of providing an electrode, in accordance with some aspects.

### DETAILED DESCRIPTION

Following below are more detailed descriptions of various concepts related to, and implementations of, methods, apparatuses, and systems of mixing materials, such as electrode material or battery active materials for battery electrode manufacturing. The various concepts introduced above and discussed in greater detail below may be implemented in any of numerous ways.

The present disclosure is directed to systems and methods of mixing. For example, the present disclosure is directed to systems and methods of mixing a material, such as an electrode material or a battery active material, which can be used to manufacture an electrode. The system can be a variable shear mixing system including at least one mixer vessel defining a chamber, at least one mixing blade, and at least one mixing element. For example, the mixer can include two mixing blades and one mixing element to mix a material within the chamber. The mixing blade can include at least one blade tip, such as a high shear tip or some other tip to create shearing forces as the mixing blade mixes the material. The mixing blade can extend into the chamber. The mixing element can be or include an inner vessel to rotate within the mixing vessel (e.g., within an outer vessel of the mixing vessel). For example, the chamber can be within the inner vessel, and the inner vessel can rotate relative to a stationary outer vessel. The mixing element can be or include at least one baffle to rotate within the chamber. For example, the baffle can extend into the chamber. The baffle can be angled relative to an inner wall of the chamber. The mixing blade and mixing element can rotate independently from each other to mix the material. For example, the mixing system can include a first mixing blade to rotate with a first rotational movement, a second mixing blade to rotate with a second rotational movement, and the mixing element to rotate with a third rotational movement. The first rotational movement of the first mixing blade can be independent from one or more of the second rotational movement and the third rotational movement.

The disclosed solutions have a technical advantage of creating high shear mixing zones within the chamber to effectively mix a material within the chamber. For example, the mixing system can create at least one high shear mixing zones, at least one medium shear mixing zone, and at least one low shear mixing zone to mix (e.g., blend, disperse, knead, homogenize, or dilute) the material within the chamber, where the various mixing zones can mix the material to create a homogenous mixture. The high shear mixing zone can be a region, area, or zone of material that experiences high shear forces, the medium shear mixing zone can be a region, area, or zone of material that experiences medium shear forces, and the low shear mixing zone can be a region, area, or zone of material that experiences low shear forces, where the high shear forces can be greater than the medium shear forces and the medium shear forces can be greater than the low shear forces. The high shear forces, medium shear forces, and low shear forces can be forces imparted to a material being mixed that cause the material to mix (e.g., blend, disperse, knead, homogenized, or dilute). The mixing system can create a homogenous or substantially homogenous (e.g., greater than 80% homogenized, greater than 90% homogenized, greater than 95% homogenized, greater than 98% homogenized, or some other degree of homogeneity) mixture within the chamber in a short amount of time because multiple mixing blades and a mixing element can be simultaneously used. The mixing blades and the mixing element can be controlled (e.g., rotated, operated, manipulated) independently. For example, each mixing blade and each mixing element can be controlled separately from other mixing blades or mixing elements. Each mixing blade or mixing element can rotate at different speeds (e.g., different RPMs, different blade tip speeds, or some other speed), in different directions (e.g., clockwise or anti-clockwise directions), or in some other different manner (e.g., in a pulsing pattern, in a plunging motion, or otherwise). For example, a first rotational movement (e.g., a rotation or partial rotation about an axis) of the first mixing blade can include the first mixing blade rotating in a first direction and at a first speed. A second rotational movement (e.g., a rotation or partial rotation about an axis) of the second mixing blade can include the second mixing blade rotating in a second direction and at a second speed, where the second direction can be different than the first direction or the second speed can be different than the first speed. A third rotational movement (e.g., a rotation or partial rotation about an axis) of the mixing element can include the mixing element rotating in the second direction or at a third speed, where the second direction can be different than the first direction or the third speed can be different than the first speed. The independent operation of the mixing blade and the mixing element can create a combination of varying shear forces within the chamber of the mixer vessel to effectively and efficiently mix a material.

The mixing blade can be adjustable. For example, a blade of the mixing blade can be detached from a shaft and replaced with a different mixing blade having different dimensions or a different blade tip design. The mixing blade can be changed to alter shear zones within the chamber to facilitate mixing of the material. The mixing blade can also extend into the chamber at a varying or dynamic height to facilitate mixing of the material within the chamber. For example, the mixing blade can move in a downwards direction or an upwards direction. The mixing blade can plunge into the chamber during a mixing operation such that a height between a bottom of the mixing blade and a bottom of the chamber (e.g., a bottom of an inner vessel) changes. The mixing element can include at least one baffle having an adjustable angle of attack relative to an inner wall of the chamber to facilitate mixing of the material within the chamber. The mixing system can include a thermal element, such as a heating jacket, a cooling jacket, or some other element to provide thermal energy to the mixer vessel to facilitate mixing. The mixing system can include a vacuum device to remove mixed material from the chamber. For example, the vacuum device can control (e.g., increase, decrease, maintain, or monitor, or otherwise influence) a pressure of the material within the chamber. The mixing system can include a conveyance device to remove mixed material from the chamber, where the mixed material can be provided to another system or device (e.g., a slot-die coating system, a hopper, a tank, or some other location) that is associated or disassociated with production of a battery electrode. The mixing system can include a gearbox to independently control the mixing blades, the mixer element, or some other device. The mixing system can include a hood to surround a shaft of the mixing blades with the mixing blades extending into the chamber. The mixing system can be customizable to provide an operator with precise or accurate control of a mixing operation.

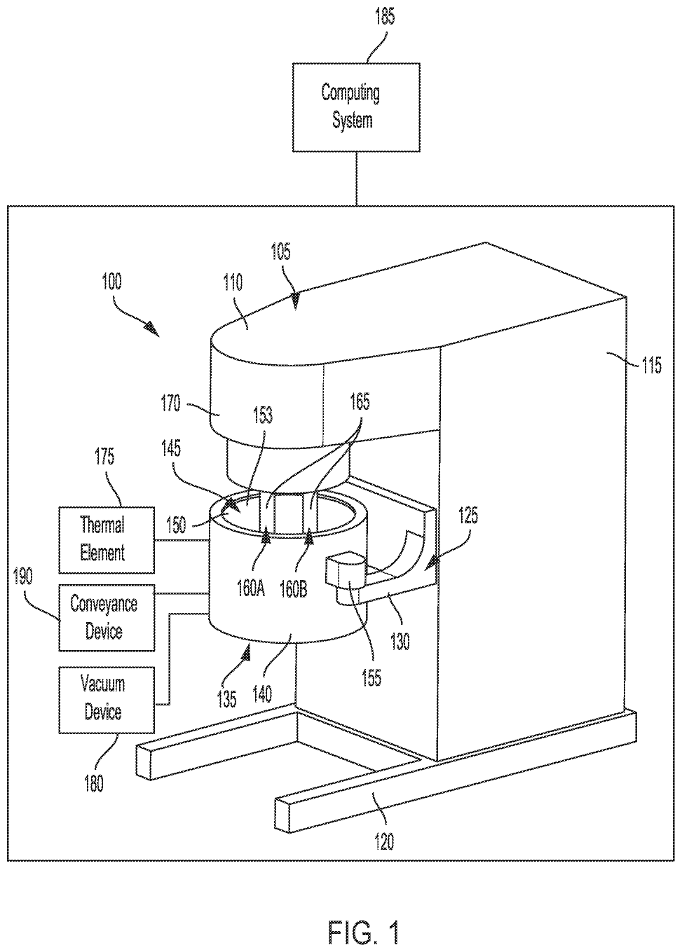

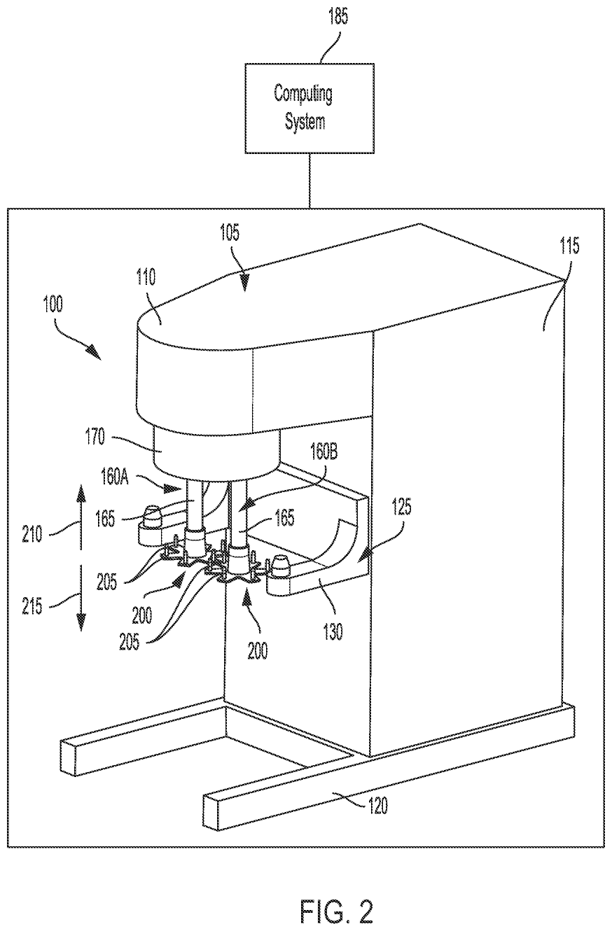

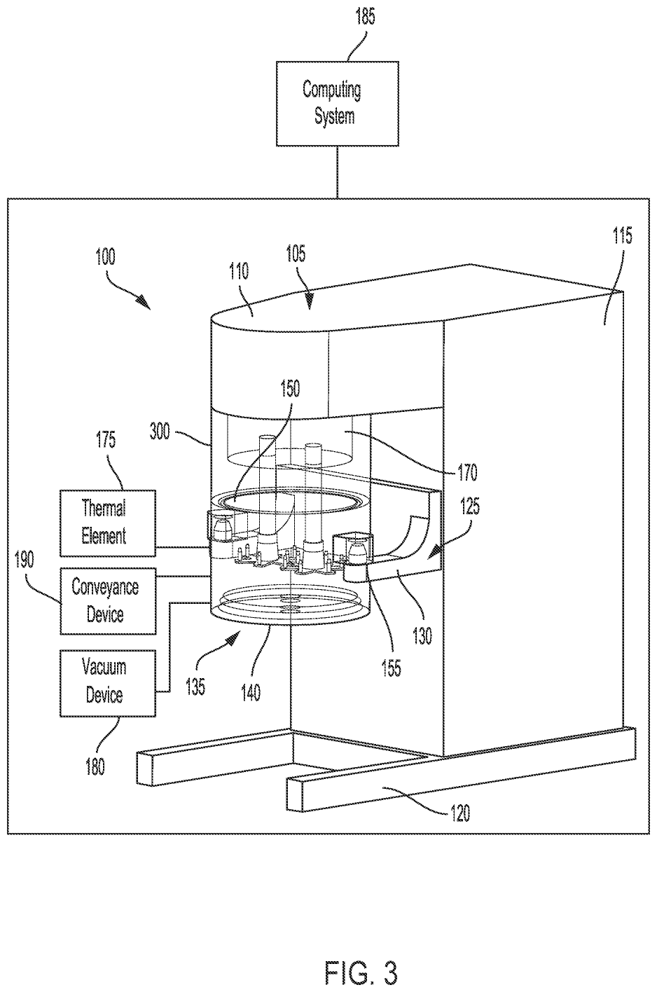

FIGS. 1-3, among others, depict a system 100. The system 100 can be a mixing system 100. The mixing system 100 can mix a material to create a homogenous or substantially homogenous (e.g., greater than 80% homogenous, greater than 90% homogeneous, greater than 95% homogeneous, greater than 98% homogeneous, or some other degree of homogeneity) mixture. For example, the mixing system 100 can receive as input one or more raw materials, such as solid particulate, liquid, or some combination of solids and liquids, and can mix the materials to create a mixed or blended material. The mixing system 100 can be used to create a slurry of electrode material (e.g., battery active material) that can be applied to a current collector material to create an electrode, for example. The mixing system 100 can include a mixer stand 105, a mixer vessel 135, at least one mixing blade 160, and at least on gearbox 170. The mixing system 100 can include or be associated with a computing system 185 coupled with a thermal element 175, a vacuum device 180, the gearbox 170, the conveyance device 190, or other components of the mixing system 100 to control the mixing system 100. The mixing system 100 can include the gearbox 170 coupled with the mixing blade 160 to cause the mixing blade to rotate within the mixer vessel 135. The mixing system 100 can include the mixing blade 160 to mix (e.g., blend, disperse, knead, homogenize, or dilute) a material within the mixer vessel 135 to create a mixed material. FIG. 2 depicts the mixing system 100 without the mixer vessel 135 shown. FIG. 3 depicts the mixing system 100 with a hood 300 shown.

The mixer stand 105 can include a top portion 110, a body portion 115, a bottom portion 120, and a holder 125. For example, the top portion 110 and the bottom portion 120 can extend from the body portion 115 of the mixer stand 105. The holder 125 can include at least one arm 130 that extends from the body portion 115 in a direction similar to the top portion 110. The holder 125 can support the mixer vessel 135. For example, the mixer vessel 135 can include at least one mounting element 155. The arm 130 of the holder 125 can support (e.g., contact, hold, retain) the mounting element 155 of the mixer vessel 135 such that the mixer vessel 135 is supported by the holder 125. The mixer vessel 135 can be supported by the holder 125 with the mixer vessel positioned at least partially underneath the top portion 110 of the mixer stand 105. For example, the gearbox 170 can be coupled with the top portion 110 of the mixer stand 105. The mixing blade(s) 160 can be coupled with the gearbox 170 and can extend in a direction from the top portion 110 towards the mixer vessel 135 with the mixer vessel 135 supported by the holder 125. For example, the mixing blade 160 can extend downwards into the mixer vessel 135 such that the mixing blade 160 extends at least partially into the mixer vessel 135. The shape, size, and configuration of the mixer stand 105, holder 125, the mixer vessel 135, and the manner in which the mixer vessel 135 is coupled with the mixer stand 105 are examples and can vary from that shown in FIGS. 1 and 3, among others.

The mixing system 100 can include the mixer vessel 135 defining a chamber 145. For example, the mixer vessel 135 can include an outer vessel 140 defining a cavity. The cavity can be the chamber 145. The chamber 145 of the mixer vessel 135 can receive a material or multiple materials. For example, the chamber 145 can receive a battery active material (e.g., an electrode material, a cathode material, an anode material), a solvent, or some other chemicals (e.g., individual ingredients of a battery active material). The mixer vessel 135 can retain the materials within the chamber 145 such that the materials can be mixed within the chamber 145 to create a homogenous or substantially homogeneous (e.g., greater than 80% homogenous, greater than 90% homogeneous, greater than 95% homogeneous, greater than 98% homogeneous, or some other degree of homogeneity) mixture. For example, the materials can remain within the chamber 145 as the mixing blade 160 mixes the materials. The mixer vessel 135 can include an open end facing upwards to receive a mixing blade 160 extending downwards such that the mixing blade 160 extends at least partially into the chamber 145.

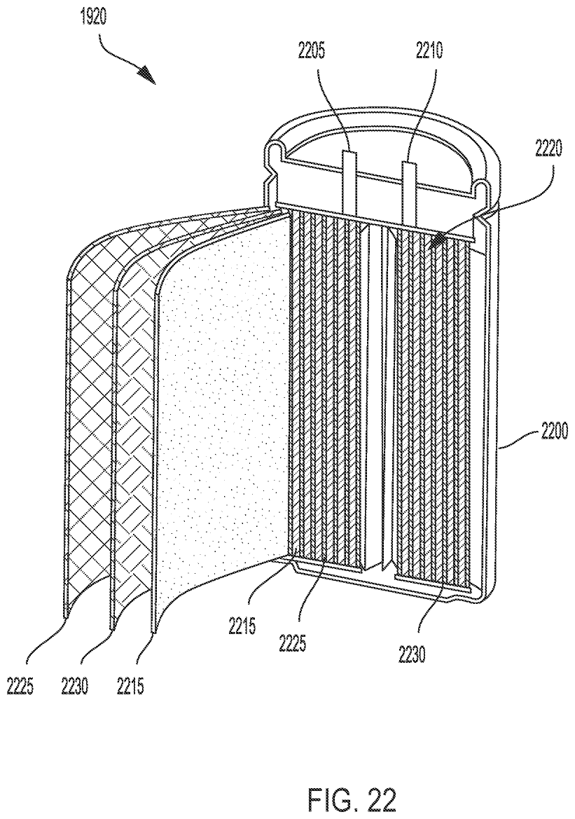

The mixing system 100 can include the chamber 145 of the mixer vessel 135 to receive materials to be mixed to form an electrode slurry. For example, the materials can include one or more ingredients, chemicals, solvents, solids, dispersants, or other contents within the chamber 145 mixer vessel 135 that, when mixed, form a slurry of electrode material or battery active material. The slurry can be used to produce an electrode (e.g., the anode electrode 2215 or the cathode electrode 2225, as discussed below and as shown in FIG. 22, among others). The materials can be mixed to create a slurry. The slurry can include a slurry viscosity. The slurry viscosity can vary according to at least one of the solid content, the solvent content, the dispersant content, or some other parameter. For example, the slurry viscosity can vary based on which ingredients are being mixed within the chamber 145 of the mixing system 100.

The mixing system 100 can mix the materials with the materials having a solid content. The solid content can be an amount or proportion of a solid material within the materials (e.g., the mixture of materials within the mixer vessel 135). For example, the solid material can be or include battery active material, a conductive material, a binder material, some other material, or some combination thereof. For example, the solid content can be a 50% solid content, a 55% solid content, a 60% solid content, a 65% solid content, greater than 65% solid content, or some other solid content. The solid content can be an amount or a proportion of solid material by weight or volume within the materials. The solid content can include a battery active material (e.g., electrode active materials), a conductive material (e.g., conductive additives), a binder material, some other material, or some combination thereof. The solid content can include the battery active material, the conductive material, the binder material, or some other material each being some proportion of the solid content.

The battery active material can be or include cathode active materials and/or anode active materials. For example, the cathode active materials can include high-nickel content (greater than or equal to 80% Ni) lithium transition metal oxide like a particulate lithium nickel manganese cobalt oxide (“LiNMC”), lithium nickel cobalt aluminum oxide (“LiNCA”), lithium nickel manganese cobalt aluminum oxide (“LiNMCA”), lithium metal phosphates like lithium iron phosphate (“LFP”), Lithium iron manganese phosphate (“LMFP”), and combinations thereof. The cathode active materials can include sulfur containing cathode active materials such as Lithium Sulfide (Li2S), lithium polysulfides, Titanium Disulfide (TiS2), and combinations thereof. The anode active materials can include graphitic carbon (e.g., ordered or disordered carbon with sp2 hybridization, artificial or natural Graphite, or blended), Li metal anode materials, silicon-based anode materials (e.g., silicon-based carbon composite anode, silicon metal, oxide, carbide, pre-lithiated), silicon-based carbon composite anode, lithium alloys (e.g., Li—Mg, Li—Al, Li—Ag alloy), lithium titanate, or combinations thereof. The conductive material can be or include graphite, carbon black, carbon nanotubes, Super P carbon black material, Ketjen Black, Acetylene Black, SWCNT, MWCNT, carbon nanofiber, graphene, and combinations thereof. The binder material can be or include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”), carboxymethylcellulose (“CMC”), agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or combinations thereof.

The materials can include a solvent content. The solvent content can be an amount or a proportion of a solvent within the materials. The solvent content can be or include n-methyl-pyrrolidone (NMP), dimethylformamide (DMF), dimethylacetamide (DMAc), dimethyl sulfoxide (DMSO), acetone, water, or some other solvent material. For example, the solvent content can include one or more liquid, semi-liquid, or other solvents. The solvent content can include a solvent to dissolve or transport a solid material within a slurry. For example, the materials can include the solid content mixed with the solvent content, where the solvent content can at least partially dissolve or distribute the solid content within the slurry.

The materials can include a dispersant content. The dispersant content can be an amount or a proportion by volume or weight of a dispersant material within the materials, such as a thermoplastic, urethane, or some other dispersant material. The dispersant material can facilitate a dispersion of one or more ingredients within the slurry (e.g., the mixed materials). For example, the dispersant material can facilitate a dispersion of the conductive material of the solid content within the slurry. The dispersed conductive material (e.g., conductive carbon additives) can promote or improve conductivity of an electrode manufactured with the slurry relative to an electrode produced with a slurry not having any dispersant. Dispersants can be included in the slurry to adjust or optimize the viscosity, speed processing or mixing time, prevent agglomeration and/or increase the distribution of conductive carbon or degree of dispersion in the slurry, and thus, homogeneity. Dispersants can promote formation of a conductive network in the resulting electrode which translates to lower resistance, higher capacity and/or greater rate capability. Various dispersants can be employed, for example block co-polymers, naphthalene sulfonates, lignosulfonates and/or the like. Furthermore, binder materials can also act as dispersants like polyvinylidene fluoride (PVDF), carboxymethyl cellulose (CMC), and/or Styrene Butadiene Rubber (SBR).

The slurry viscosity can increase as the solid content or increases or as the solvent content decreases. For example, the slurry viscosity can be directly or indirectly affected by an increase in the solid content of the materials. The slurry viscosity can be 2500 cPs with the solid content being 50% by weight of the materials. The slurry viscosity can be 25,000 cPs with the solid content being 60% by weight of the materials. For example, the slurry viscosity can increase exponentially or at some rapid rate as the solid content of the materials is increased. The slurry viscosity can increase as the solvent content decreases. For example, as less solvent is used in the materials, the slurry viscosity can increase. The materials can be increasingly difficult to mix with the solid content increased and the slurry viscosity also increased. For example, a shear force or some other force required to mix the material within the mixer vessel 135 can increase as the solid content of the materials is increased or as the slurry viscosity is increased. It can be more difficult to achieve a homogeneous or substantially homogeneous mixture (e.g., ±greater than 80% homogenous, greater than 90% homogeneous, greater than 95% homogeneous, greater than 98% homogeneous, or some other degree of homogeneity) with the solid content increased and the slurry viscosity increased because the shear forces required can also be increased. In addition, the slurry can become increasingly difficult to handle (e.g., store, convey, coat, etc.) with the slurry viscosity increased.

As depicted in FIGS. 1, 3, and 4, among others, the mixing system 100 can include an inner vessel 150. For example, the mixer vessel 135 can include an inner vessel 150. For example, the mixer vessel 135 can include an inner vessel 150 positioned within the outer vessel 140. The inner vessel 150 can define the chamber 145 of the mixer vessel 135. For example, the inner vessel 150 can define a cavity to receive a material with the inner vessel 150 positioned within (e.g., nested within) the outer vessel 140. The inner vessel 150 can be rotatable relative to the outer vessel 140. For example, the outer vessel 140 can be a stationary outer vessel and the inner vessel 150 can rotate relative to the outer vessel with the inner vessel positioned within the outer vessel. The inner vessel 150 can include a bottom 400 and an aperture 405. The outer vessel 140 can include a bottom 410 and an aperture 415. The bottom 400 of the inner vessel 150 can be positioned proximate to (e.g., within three inches of) or against (e.g., abutting, contacting) the bottom 410 of the outer vessel 140. The aperture 405 of the inner vessel 150 can be concentric with the aperture 415 of the outer vessel 140. For example, the aperture 405 of the inner vessel 150 can be positioned at a center of the bottom 400 of the inner vessel 150 and the aperture 415 of the outer vessel 140 can be positioned at a center of the bottom 410 of the outer vessel 140. The inner vessel 150 can rotate within the outer vessel 150 about an axis 425. For example, the axis 425 can extend through the aperture 405 of the inner vessel 150 and the concentric aperture 415 of the outer vessel 140. The axis 425 can be a central axis of the inner vessel 150 and a central axis of the outer vessel 140 such that the inner vessel 150 and the outer vessel 140 are concentric. For example, the inner vessel 150 and the outer vessel 140 can include a generally cylindrical shape or a generally circular cross-sectional shape.

The outer vessel 140 can include a top 420. For example, the inner vessel 150 can be positioned within the outer vessel 140 such that the inner vessel 150 is between the bottom 410 and the top 420 of the outer vessel 140. The inner vessel 150 can be captured (e.g., retained, trapped) between the top 420 and the bottom 410 of the outer vessel 140 such that the inner vessel 150 cannot be removed from the outer vessel 140. A friction-reducing element, such as at least one bearing, a lubricant (e.g., a fluid, a solid, a paste, or some other material) or some other friction-reducing element can be positioned between the inner vessel 150 and the outer vessel 140 to facilitate a rotation of the inner vessel 150 relative to the outer vessel 140. For example, the inner vessel 150 can rotate (e.g., spin) about the axis 425 with the inner vessel 150 positioned within the outer vessel 140 and with at least one friction-reducing element between the inner vessel 150 and the outer vessel 140.

The mixing system 100 can include the mixer vessel 135 having a stationary outer vessel 140. For example, the outer vessel 140 can remain stationary (e.g., be held in place, be prevented from rotating) as the inner vessel 150 rotates within the outer vessel 140. The mixer vessel 135 (e.g., the outer vessel 140) can include the mounting element 155 to interact (e.g., engage) with the arm 130 of the holder 125 extending from the body portion 115 of the mixer stand 105. For example, the arm 130 can be rigidly coupled with the mixer stand 105 such that the arm 130 does not rotated, bend, flex, or otherwise move with the mixer vessel 135 coupled with the arm 130. The mixer vessel 135 can include two or more of the mounting elements 155 (e.g., a first mounting element 155 diametrically opposed from a second mounting element 155) to keep the mixer vessel 135 from rotating. For example, the mounting elements 155 can prevent the mixer vessel 135 (e.g., the outer vessel 140) from rotating.

The inner vessel 150 can be coupled with a rotating mechanism to rotate the inner vessel within the outer vessel 140. For example, the rotating mechanism can be an electric motor or some other motor that can cause an output member (e.g., a shaft) to rotate when operating. The output member can be coupled with the inner vessel 150 directly or indirectly (e.g., through at least one gear, at least one linkage, or some other mechanical coupling mechanism) such that the rotation of the output member can cause a corresponding rotation of the inner vessel 150. The rotating mechanism can be the gearbox 170 or some other device. The rotating mechanism can be coupled with the computing system 185, as is discussed in detail below.

As depicted in FIGS. 1-4, among others, the mixing system 100 can include the mixing blade 160 to mix (e.g., blend, disperse, knead, homogenize, or dilute) a material within the chamber 145 of the mixer vessel 135. For example, the mixing system 100 can include a first mixing blade 160A and a second mixing blade 160B (collectively referred to herein as the mixing blade 160). The mixing blade 160 can include a shaft 165 and at least one blade 200. For example, the mixing blade 160 can include the blade 200 coupled with a first end of the shaft 165. The blade 200 can be coupled with the shaft 165 such that a rotation of the shaft 165 can cause a corresponding rotation of the blade 200. The shaft 165 can be coupled with the gearbox 170. For example, the shaft 165 can be rotatably coupled with the gearbox 170 such that the gearbox can cause the shaft 165 to rotate. The gearbox 170 can cause the shaft 165 to rotate, which can further cause the blade 200 to rotate.

The mixing system 100 can include the mixing blade 160 to mix a material within the chamber 145. For example, the mixing system 100 can include the first mixing blade 160A and the second mixing blade 160B to mix (e.g., blend, disperse, knead, homogenize, or dilute) a material within the chamber 145 of the mixer vessel 135. The chamber 145 of the mixer vessel 135 can be defined by the inner vessel 150 or an inner wall of the mixer vessel 135 (e.g., an inner wall of the outer vessel 140 if no rotating inner vessel 150 is present). The blade 200 of the first mixing blade 160A and the blade 200 of the second mixing blade 160B can be submerged in material with the chamber 145 at least partially filled with material to be mixed. For example, the blades 200 can extend into material occupying the chamber 145 or a portion of the chamber 145 to mix the material. A rotation of the blades 200 can cause the material to mix.

The first mixing blade 160A can extend at least partially into the chamber 145 of the mixer vessel 135. For example, the blade 200 of the first mixing blade 160A can extend into the chamber 145. The blade 200 can include a bottom 430. The bottom 430 of the blade 200 can be spaced apart from the bottom 400 of the inner vessel 150 (or the bottom 410 of the outer vessel 140 in instances where no inner vessel 150 is used) by a distance 435. The shaft 165 of the first mixing blade 160A can extend upwards away from the bottom 400 of the inner vessel 150 and towards the gearbox 170. The second mixing blade 160B can extend at least partially into the chamber 145 of the mixer vessel 135. For example, the blade 200 of the second mixing blade 160B can extend into the chamber 145. The blade 200 can include a bottom 430. The bottom 430 of the blade 200 can be spaced apart from the bottom 400 of the inner vessel 150 (or the bottom 410 of the outer vessel 140 in instances where no inner vessel 150 is used) by a second distance 435. The bottom 430 of the blade 200 of the first mixing blade 160A and the bottom 430 of the blade 200 of the second mixing blade 160B can be spaced apart from the bottom 400 of the inner vessel 150 by different distances 435. For example, the blade 200 of the first mixing blade 160A can be positioned at a first distance 435 from the bottom 400, while the blade 200 of the second mixing blade 160B can be positioned a second distance 435 from the bottom, where the first distance 435 and the second distance 435 can be different. The shaft 165 of the second mixing blade 160B can extend upwards away from the bottom 400 of the inner vessel 150, towards the gearbox 170, and parallel or substantially parallel (e.g., ±15° from parallel) with the shaft 165 of the first mixing blade 160A. The blade 200 of the first mixing blade 160A or the second mixing blade 160B can move in a downwards direction 215 towards the bottom 400 or an upwards direction 210 away from the bottom 400. For example, the first mixing blade 160A or the second mixing blade 160B can plunge into the chamber 145 during a mixing operation such that the distance 435 between the blade bottom 430 and the bottom 400 of the inner vessel 150 can change or be dynamic. For example, the gearbox 170 can cause the shaft 165 of the first mixing blade 160A or the second mixing blade 160B to move in either the direction 210 or the direction 215 to cause the blade 200 of the first mixing blade 160A or the second mixing blade 160B to plunge into or retreat from the chamber 145.

The blade 200 of the mixing blade 160 can include a blade tip 205. For example, the blade 200 of the first mixing blade 160A or the blade 200 of the second mixing blade 160B can include the blade tip 205. The blade tip 205 of the first mixing blade 160A can be the same as or different than the blade tip 205 of the second mixing blade 160B. The blade tip 205 can extend outwardly from the blade 200 or from the shaft 165 to which the blade 200 is coupled in one or more directions (e.g., upwards, downwards, radially, or in some other direction). The blade tip 205 can extend from the blade 200 to mix the material within the chamber 145. For example, the blade 200 of the first mixing blade 160A and the blade 200 of the second mixing blade 160B can each include a blade tip 205 to facilitate a mixing of the material. The blade tip 205 can create turbulence or shear forces within the material occupying the chamber 145 as the blade 200 rotates. For example, the blade tip 205 can rotate as the blade 200 rotates, where rotation of the blade tip 205 can impose a shear force on the material present within the chamber 145 of the mixer vessel 135. The blade tip 205 can cause the material to mix (e.g., blend, disperse, knead, homogenize, or dilute) as the blade tip 205 rotates within the material. The blade tip 205 can include a geometry (e.g., shape) or dimension (e.g., size) to facilitate mixing. For example, a blade 200 can include multiple blade tips 205 having a geometry and dimension designed to facilitate mixing of a particular material or a material having particular material properties (e.g., a viscosity, a solid content, or other parameter). The shape, size, or configuration of the blade tip 205 can vary. The direction or angle in which the blade tip 205 extends from the shaft 165 can vary.

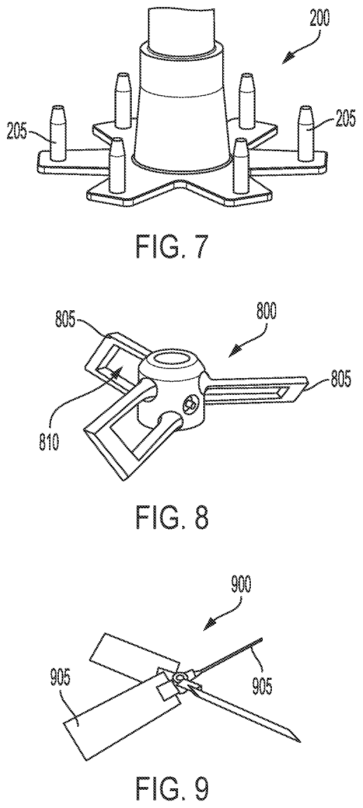

The blade 200 of the mixing blade 160 can be removable. For example, the blade 200 can be detachably (e.g., removably) coupled with the shaft 165 of the mixing blade 160 such that the blade 200 can be removed or decoupled from the shaft 165. The blade 200 can be detachably coupled with the shaft 165 via at least on fastener or other securing means (e.g., threads, adhesive, magnetic force, or some other means). The blade 200 can be removed from the shaft 165 and replaced with another blade 200. For example, the blade 200 having a first blade geometry or dimension can be removed from the shaft 165 and replaced with a blade having a second blade geometry or dimension. For example, the mixing system 100 can be used to mix a variety of materials. Certain materials can be efficiently mixed with the first blade 200 having the first blade geometry, while other materials can be efficiently mixed with the second blade 200 having the second blade geometry. The blades 200 can be detachably coupled with the shaft 165 such that the blade 200 can be removed or replaced according to the needs of the mixing system 100 at a particular time (e.g., as the material to be mixed changes from batch-to-batch or otherwise). As depicted in FIGS. 7-17 and described in detail below, various blades 200, 700, 800, 900, 1000, 1100, 1200, 1300, 1400, 1500, 1600, 1700, or other blades can be coupled with the shaft 165 of the mixing blade 160 to facilitate mixing of various materials.

The mixing system 100 can include the first mixing blade 160A including the blade 200 having a first blade geometry and the second mixing blade 160B including the blade 200 having a second blade geometry. For example, the mixing system 100 can include multiple mixing blades 160, where at least one of the mixing blades 160 includes a blade 200 having a geometry that differs from a geometry of at least one other blade 200 of the a mixing blade 160. The first blade geometry of the blade 200 of the first mixing blade 160A can be different than the second blade geometry of the blade 200 of the second mixing blade 160B. The blade 200 of the first mixing blade 160A can include a blade tip 205 having a first geometry or a first dimension, while the blade 200 of the second mixing blade 160B can include a blade tip 205 including a second geometry or a second dimension, where one or both of the second geometry or the second dimension respectively differs from the first geometry or the first dimension. The blade 200 of the first mixing blade 160A can include the first blade geometry to create a first shearing force within the material as the blade 200 rotates. The blade 200 of the second mixing blade 160B can include the second blade geometry to create a second shearing force within the material as the blade 200 rotates within the material. The first shearing force can be different than the second shearing force. For example, with the blade 200 of the first mixing blade 160A rotating at a similar speed to the blade 200 of the second blade 200, the first shearing force can be greater or less than the second shearing force.

The mixing system 100 can include the gearbox 170 coupled with the mixing blade 160. For example, the system 100 can include the gearbox 170 coupled with the mixing blade 160 to cause the mixing blade 160 to rotate with the blade 200 of the mixing blade 160 within the chamber 145 or within material occupying the chamber 145. The gearbox 170 can include at least one rotating member or gear that, when the gearbox is powered or operating, can rotate. For example, the gearbox 170 can be or include an electrically operated motor or other device that, when powered, can rotate a gear, shaft, or other rotating member. The rotation of the gear, rotating member, or shaft can cause a corresponding rotation of another member, such as the shaft 165 of a mixing blade 160. For example, the rotation of the gear, shaft, or rotating member of the gearbox 170 can cause the shaft 165 of at least one mixing blade 160 to rotate, where the rotation of the shaft 165 can cause a corresponding rotation of a blade 200 of the mixing blade 160 to mix (e.g., blend, disperse, knead, homogenize, or dilute) a material within the chamber 145.

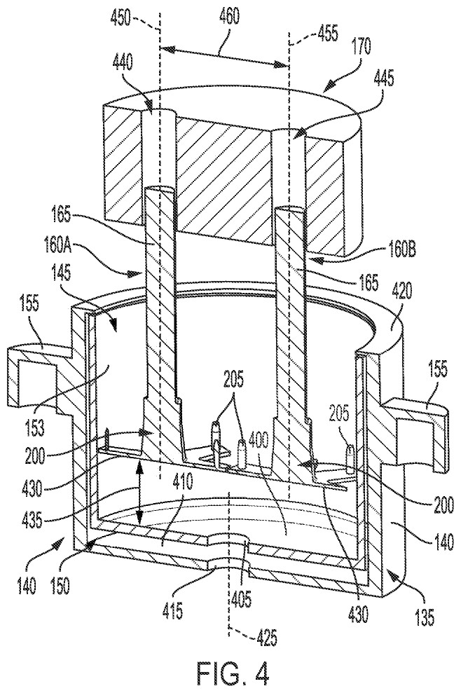

The shaft 165 of the first mixing blade 160A can be received in an aperture (e.g., opening, hole, bore) of the gearbox 170. As depicted in FIG. 4, among others, the shaft 165 of the first mixing blade 160A can be received in a first aperture 440 (e.g., opening, bore, hole) of the gearbox 170. The aperture 440 can be a bore of a gear within the gearbox 170. The aperture 440 can define an axis 450. The shaft 165 can rotate about the axis 450 with the shaft 165 received in the aperture 440. For example, the operation of the gearbox 170 or a portion of the gearbox 170 (e.g., one or more gears or rotating members associated with the aperture 440) can cause the shaft 165 of the first mixing blade 160A to rotate about the axis 450. The rotation of the shaft 165 can cause a corresponding rotation of the blade 200 of the first mixing blade 160A about the axis 450. For example, the operation of the gearbox 170 to rotate the shaft 165 can cause the blade 200 of the first mixing blade 160A to rotate about the axis 450.

The shaft 165 of the second mixing blade 160B can be received in an aperture (e.g., opening, hole, bore) of the gearbox 170. As depicted in FIG. 4, among others, the shaft 165 of the second mixing blade 160B can be received in a second aperture 445 (e.g., opening, bore, hole) of the gearbox 170. The aperture 445 can be a bore of a gear within the gearbox 170. The aperture 445 can define an axis 455. The shaft 165 can rotate about the axis 455 with the shaft 165 received in the aperture 445. For example, the operation of the gearbox 170 or a portion of the gearbox 170 (e.g., one or more gears or rotating members associated with the aperture 440) can cause the shaft 165 of the second mixing blade 160B to rotate about the axis 455. The rotation of the shaft 165 can cause a corresponding rotation of the blade 200 of the second mixing blade 160B about the axis 450. For example, the operation of the gearbox 170 to rotate the shaft 165 can cause the blade 200 of the second mixing blade 160B to rotate about the axis 455.

The gearbox 170 can include the axis 450 of the aperture 440 spaced apart from the axis 455 of the second aperture 445 by a distance 460. For example, the distance 460 can be a sufficiently large distance to space the shafts 165 of the first mixing blade 160A and the second mixing blade 160B apart from each other such that each of first mixing blade 160A and the second mixing blade 160B can rotate about the axis 450 and 455, respectively, without the blades 200 of each mixing blade 160 contacting (e.g., crashing into) each other. The distance 460 can be a fixed distance or the distance 460 can be variable. For example, a position of one or more gears or rotating members of the gearbox 170 can be moved to alter the distance 460.

The mixing system 100 can include a thermal element 175. For example, the mixing system 100 can include the thermal element 175 to provide thermal energy to the chamber 145 of the mixer vessel 135. The thermal element 175 can be thermally coupled with the mixer vessel 135 to provide thermal energy to a material (e.g., a blend of materials) within the chamber 145 to alter a temperature of the material. For example, the thermal element 175 can be a heating jacket or a cooling jacket surrounding the mixer vessel 135, one or more conduits or lumens to conduct a flow of a heated or cooled fluid, a resistive heating element, an air circulation device (e.g., a fan), or some other device to provide heating energy or cooling energy. The thermal element 175 can generate heating or cooling energy that can be conducted through the mixer vessel 135 to alter a temperature within the chamber 145 of the mixer vessel 135. For example, the thermal element 175 can increase or decrease a temperature of the material within the chamber 145 to facilitate the mixing of the material within the chamber 145. The thermal element 175 can provide heating or cooling energy to the mixer vessel 135 to maintain a temperature within the chamber 145. For example, the thermal element 175 can provide heating or cooling energy to the mixer vessel 135 to maintain a temperature within the chamber 145 that is hotter or colder than an ambient temperature (e.g., a temperature of an environment surrounding the mixer vessel 135 or the mixing system 100).

As depicted in FIGS. 1 and 3, the mixing system 100 can include at least one vacuum device 180. For example, the mixing system 100 can include the vacuum device 180 to control a pressure within the chamber 145 of the mixing system 100. The vacuum device 180 can control increase, decrease, monitor, maintain, or otherwise control a pressure within the chamber 145. For example, the vacuum device 180 can maintain a predetermined or a desired temperature within the chamber 145 as the mixing system 100 mixes the material within the chamber 145. For example, the vacuum device 180 can be or include a vacuum pump to create a vacuum or a vacuum pressure. The vacuum device 180 can pull a vacuum or apply the vacuum pressure within the chamber 145 to affect a pressure of the material or a pressure of the chamber 145 of the mixer vessel 135. For example, the vacuum device 180 can control a pressure under which a mixing operation occurs. The pressure can be a vacuum pressure, a pressure lower than an atmospheric pressure, an atmospheric pressure, an elevated pressure relative to or some other pressure, or some other pressure.

As depicted in FIGS. 1 and 3, the mixing system 100 can include at least one conveyance device 190. For example, the mixing system 100 can include the conveyance device 190 to remove material from the chamber 145 or to provide the material from the chamber 145 to another location, device, or system. The conveyance device 190 can be fluidly coupled with the chamber 145 to evacuate (e.g., remove, draw out, pull) material from the chamber 145. For example, the conveyance device 190 can be a vacuum pump to remove mixed material from the chamber 145 after a mixing operation has been completed. The conveyance device 190 can be fluidly coupled with the chamber 145 via an aperture in the mixer vessel 135. For example, the conveyance device 190 can be fluidly coupled with the chamber 145 of defined by the inner vessel 150 via the aperture 405 of the inner vessel 150 and the aperture 415 of the outer vessel 140. The conveyance device 190 can include a vacuum pump to create a vacuum or vacuum pressure. The vacuum or vacuum pressure can draw (e.g., pull, suck) mixed material from the chamber 145 with the conveyance device 190 fluidly coupled with the chamber 145. The conveyance device 190 can be some other system, machine, device, or apparatus to convey material from the chamber 145 to another location. For example, the conveyance device can be a mechanical conveyor, a step conveyance device, a vibrational conveyance device, a pneumatic conveyance device, or some other conveyance device. The conveyance device 190 can remove mixed material from the chamber 145 and can provide the mixed material to another system, machine, device, or apparatus. The conveyance device 190 can provide a liquid, semi-liquid, viscous, semi-solid, or solid material from the chamber 145 to some other system, machine, device, or apparatus. For example, the mixed material can be a slurry, viscous or semi-viscous electrode material, a fluid, a mixture of fluid and solid battery active particulate, or some other composition. The mixed material can be provided to a slot-die coating system or some other machine for use in electrode manufacture. For example, the conveyance device 190 can remove the mixed material from the chamber 145 and provide the mixed material to a slot-die coating system, where the mixed material can be applied to (e.g., coated on) a current collector material to create an electrode. The conveyance device 190 can provide the mixed material directly to the slot-die coating system (e.g., without first providing the material to some intervening device or system). The conveyance device 190 can provide the mixed material from the chamber 145 to a storage tank, a hopper, or some other vessel. The conveyance device 190 can provide the mixed material from the chamber 145 to another device or system.

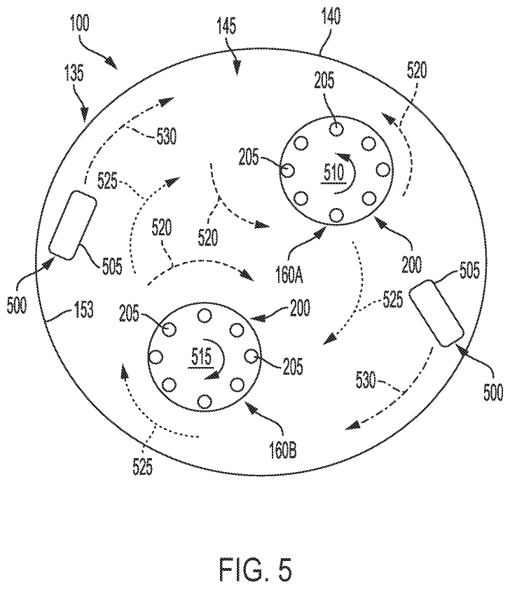

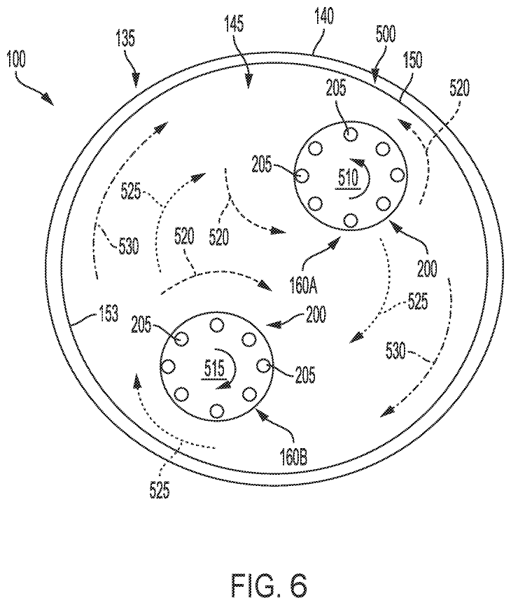

The mixing system 100 can include a computing system 185. For example, the mixing system 100 can include a computing system 185 to control an operation of the mixing system 100 or various components, devices, or systems thereof. The computing system 185 can be communicably coupled with the gearbox 170, the thermal element 175, the vacuum device 180, the conveyance device 190, or any other device associated with the mixing system 100. The computing system 185 can be communicably coupled with the gearbox 170 to control the gearbox 170. For example, the computing system 185 can cause the gearbox 170 to increase a rotational speed of a mixing blade 160 or alter a direction of rotation of the mixing blade 160. The computing system 185 can be communicably coupled with the thermal element 175 to control the thermal element 175. For example, the computing system 185 can cause the thermal element 175 to generate heating energy or cooling energy, cease generation of heating energy or cooling energy, maintain a particular temperature within the chamber 145 (e.g., a temperature as measured by a thermocouple or other thermal device within the chamber 145), or otherwise alter a temperature of the material within the chamber 145. The computing system 185 can be communicably coupled with the vacuum device 180. For example, the computing system 185 can cause the vacuum device 180 to pressurize or otherwise influence a pressure of the chamber 145 or the material within the chamber. The computing system 185 can be communicably coupled with the conveyance device 190 to control the conveyance device 190. For example, the computing system 185 can cause the conveyance device 190 to apply a vacuum pressure to draw mixed material from the chamber 145 of the mixer vessel 135, to alter a magnitude of a vacuum pressure, or to otherwise change an operation. The computing system 185 can be communicably coupled with other components, devices, or systems of the mixing system 100 to control the operation of those components, devices or systems. For example, the computing system 185 can be communicably coupled with a mixing element (e.g., the mixing element 500, as shown in FIGS. 5-6 and as discussed below) to control a rotation or operation of the mixing element.

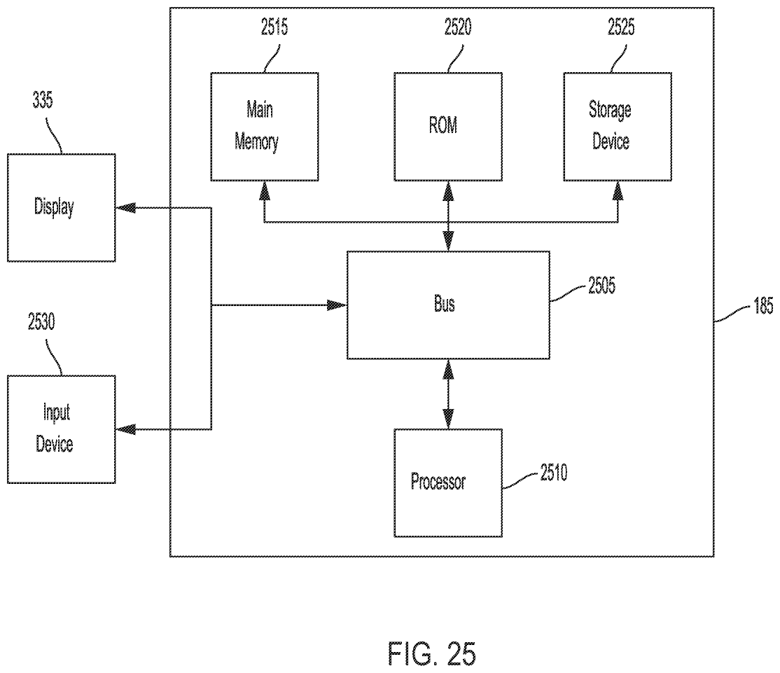

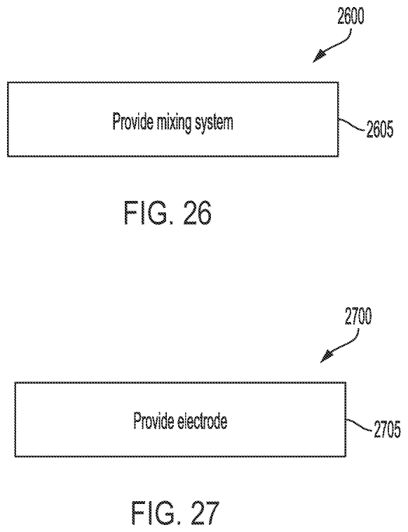

The computing system 185 can include or can access one or more programs, procedures, protocols, or predetermined operations to facilitate a mixing operation. For example, the computing system 185 can include program to operate the mixing system 100 to mix (e.g., blend, disperse, knead, homogenize, or dilute) a particular material within the chamber 145 of the mixer vessel 135. The program can include a command to the gearbox 170 to operate a first mixing blade 160A in a particular manner, to operate a second mixing blade 160B in a particular manner, to operate a mixing element (e.g., the mixing element 500 shown in FIGS. 5-6 and discussed below) in a particular manner, to operate the thermal element 175 in a particular manner, to operate the vacuum device 180 in a particular manner, or to operate the conveyance device 190 in a particular manner. For example, the program can cause the first mixing blade 160A to rotate in a first direction and at a first speed according to a first rotational movement. The program can cause the second mixing blade 160B to rotate in a second direction and at a second speed according to a second rotational movement. The computing system 185 can cause the mixing element to rotate in the second direction and at a third speed according to a third rotational movement. The program can cause the respective speeds or rotational directions of the first mixing blade 160A, second mixing blade 160B, mixing element, or other device to change over time (e.g., increase, decrease, pulse, or otherwise vary). The program can cause the blade bottom 430 approach or recede from the bottom 400 of the inner vessel 150 to alter the distance 435. For example, the program can cause the mixing blade 160 to plunge into the chamber 145 (e.g., move in the direction 215) or retreat out of the chamber 145 (e.g., move in the direction 210) during a mixing operation. The computing system 185 can include, access, or execute multiple programs or sequences. For example, the computing system 185 can execute a first program to mix a first material (e.g., a cathode electrode material) and a second program to mix a second material (e.g., an anode electrode material). The computing system 185 is shown in greater detail in FIG. 25 and further discussed below.

As depicted in FIG. 3, among others, the mixing system 100 can include a hood 300. For example, the mixing system 100 can include the hood 300 positioned around at least a portion of the first mixing blade 160A and the second mixing blade 160B with the first mixing blade 160A and the second mixing blade 160B extending into the chamber 145. The hood 300 can surround a portion of the mixing system 100 to prevent objects, debris, contaminants, or other items from interfering with an operation of the mixing system 100. For example, the hood 300 can surround at least a portion of the gearbox 170, at least a portion of the shaft 165 of the mixing blade 160, or at least a portion of the mixer vessel 135. A gap or space can exist between the top portion 110 of the mixer stand 105 and the top of the mixer vessel 135 (e.g., the top 420 of the outer vessel 140). For example, the shaft 165 of the mixing blade 160 can extend from the gearbox 170 to the chamber 145 within the gap. The chamber 145 of the mixer vessel 135 can be visible or accessible via the gap. The hood 300 can extend within or over the gap between the mixer vessel 135 and the top portion 110. For example, the hood 300 can extend from a top of the mixer vessel 135 to the top portion 110 of the mixer stand 105 such that the gap is completely or partially closed. The hood 300 can prevent an object or individual from accessing the chamber 145 during a mixing operation. The hood 300 can prevent an object or individual from interfering with the gearbox 170 or the mixing blade 160 (e.g., the shaft 165 of the mixing blade 160) during a mixing operation. The hood 300 can be detachably or rotatably coupled with the mixer stand 105 to provide selective access to the chamber 145. For example, the hood 300 can be coupled with the mixer stand 105 via a hinge or other flexible joint such that the hood 300 can be moved to reveal the gap.

FIGS. 5 and 6, among others, depict the mixing system 100 including a mixing element 500. For example, the mixing system 100 can include a mixing element 500 to mix (e.g., blend, disperse, knead, homogenize, or dilute) a material within the chamber 145. As depicted in FIG. 5, the mixing element 500 can be at least one baffle 505. The baffle 505 can extend into the chamber 145 to mix a material within the chamber 145. For example, the baffle 505 can extend downwards from the gearbox 107 or the top portion 110 of the mixer stand 105 into the chamber 145. The baffle 505 can be a slender member, blade, panel, paddle, or other device to mix the material within the chamber 145. The baffle 505 can include a rectangular cross-sectional shape, an arcuate cross-sectional shape, or some other cross-sectional shape. For example, the baffle 505 can move in a circular path within the chamber 145 to mix the material. The baffle 505 can follow a circular or substantially circular path within the chamber 145 and proximate to (e.g., within five centimeters, within one centimeter) of an inner wall 153 of the chamber 145. For example, the baffle 505 can move along a circular path within the chamber 145 where the path forms a circle about a central axis of the mixing vessel, such as the axis 425. For example, the baffle 505 can rotate about an axis (e.g., the axis 425 or a central axis of the mixer vessel 135) that is different than a central axis of the baffle 505 itself. The baffle 505 can be oriented at an angle relative to the inner wall 153 of the chamber 145. For example, the baffle 505 can be angled relative to the inner wall 153 such that one end of the baffle 505 is closer to the inner wall 153 than a second end. The angle of the baffle 505 can be varied such that one end of the baffle 505 can be closer to the inner wall 153 in one configuration and farther from the inner wall 153 in another configuration.

The baffle 505 can move within the chamber 145 to mix the material. For example, the baffle can move in a circular path within the chamber 145 to stir, mix, or blend a material occupying the chamber 145. The baffle 505 can extend into the material occupying the chamber 145 such that a movement of the baffle 505 (e.g., a movement in a circular path) can cause the material within the chamber 145 to move. The movement of the baffle 505 can introduce a shearing force into the material occupying the chamber 145, and the shearing force can cause the material to mix, blend, disperse, knead, homogenize, or dilute the material. For example, the material in the chamber 145 can be or include a variety of ingredients or components, including at least one solid material (e.g., a powdered, semi-wet, or semi-dry material) or at least one liquid material. The material can include, for example, a battery active material, a solvent, or another material. The movement of the baffle 505 within the material can cause the ingredients of the material to mix, blend, disperse, knead, homogenize, or dilute the material. For example, the shear forces introduced via the movement of the baffle 505 can mix the material within the chamber 145.

As depicted in FIG. 6, among others, the mixing element 500 can be the inner vessel 150. For example, the mixing element 500 can be or include the inner vessel 150 of the mixer vessel 135. The inner vessel 150 can be positioned within the outer vessel 140 of the mixer vessel 135, where the outer vessel 140 can be stationary. The inner vessel 150 can define the chamber 145. For example, material to be mixed by the mixing system 100 can be positioned within the chamber 145 of the inner vessel 150. The inner vessel 150 can rotate relative to the stationary outer vessel 140 to mix the material within the chamber. For example, the inner vessel 150 can rotate about a central axis (e.g., the axis 425) with the inner vessel 150 positioned within (e.g., captured by) the outer vessel 140. The rotation of the inner vessel 150 can mix the material within the chamber 145. For example, the rotation of the inner vessel 150 can cause the material within the chamber 145 to rotate. Rotation of the material within the chamber 145 can cause the material to mix (e.g., blend, disperse, knead, homogenize, or dilute). For example, the rotation of the inner vessel 150 can cause the material within the chamber 145 to swirl, stir, or otherwise mix. The inner wall 153 of the inner vessel 150 can be or include a smooth surface. For example, the inner wall 153 can be a mirror-finished surface or a surface with a low or negligible surface roughness (e.g., Ra value).

The mixing element 500 can be coupled with the gearbox 170 or another rotating mechanism or device. For example, the mixing element 500 (e.g., the baffle 505 or the rotating inner vessel 150) can be actuated, moved, or rotated by the gearbox 170 or another rotating mechanism. The baffle 505 can be coupled with the gearbox 170 and can extend from the gearbox 170 into the chamber 145. The baffles 505 can be coupled with the gearbox 170 such that an operation of the gearbox 170 (e.g., rotation of a gear, rotating member, or other component of the gearbox 170) can cause the baffle 505 to move within the chamber 145. For example, operation of the gearbox 170 can cause the baffle 505 to move along a circular path about a central axis of the chamber 145 (e.g., the axis 425) within the chamber 145 to mix (e.g., blend, disperse, knead, homogenize, or dilute) the material. In circumstances where the mixing element 500 is the rotating inner vessel 150, the inner vessel 150 can be coupled with the gearbox 170 or another rotating mechanism (e.g., an electric motor) to rotate the inner vessel 150. For example, the rotating mechanism can be an electric motor, some other motor, or another displacement-generating device that can cause an output member (e.g., a shaft) to rotate when operating or when powered. The output member can be coupled with the inner vessel 150 directly or indirectly (e.g., through at least one gear, at least one linkage, or some other mechanical coupling mechanism) such that the rotation of the output member can cause a corresponding rotation of the inner vessel 150.

The mixing blade 160 can be positioned proximate the inner wall 153 of the mixer vessel 135. For example, the mixing blade 160 can include the blade 200 having a blade tip 205 extending radially from the blade 200 and towards the inner wall 153 of the mixer vessel 135. As depicted in FIGS. 4-6, among others, one or more of the mixing blades 160 can be positioned off-center within the chamber 145. For example, a blade tip 205 of the blade 200 can be proximate to (e.g., within five centimeters, within two centimeters, within one centimeter, or within some other distance) a point on the inner wall 153. As the blade 200 rotates within the chamber 145 the blade tip 205 can approach, but not contact, the inner wall 153. For example, material positioned in a region between the blade 200 (e.g., the blade tip 205) and the inner wall 153 can experience relatively high shear forces because of the close proximity of the blade tip 205 to the inner wall 153.

The mixing system 100 can include the first mixing blade 160A to rotate with a first rotational movement. The first rotational movement can include the first mixing blade 160A rotating in a first direction. For example the first direction can be a clockwise or anti-clockwise direction. The first rotational movement can include the first mixing blade 160A rotating at a first speed. The first rotational movement can include the first mixing blade 160A rotating with the blade 200 at a first depth (e.g., the blade bottom 430 spaced apart from the bottom 400 of the inner vessel 150 by a first distance 435). The first rotational movement can include the blade 200 of the first mixing blade 160A having a blade tip 205 rotating with a first blade tip speed. The first rotational movement can include the first mixing blade 160A rotating according to a first program or sequence (e.g., fluctuating speed over time, varying rotational direction over time, varying depth of the blade 200 over time, or varying over time in some other way). The first rotational movement of the first mixing blade 160A can be controlled or monitored by the computing system 185, for example.

The mixing system 100 can include the second mixing blade 160B to rotate with a second rotational movement. The second rotational movement can include the second mixing blade 160B rotating in a second direction. For example the second direction can be an anti-clockwise or clockwise direction. The second rotational movement can include the second mixing blade 160B rotating at a second speed. The second rotational movement can include the second mixing blade 160B rotating with the blade 200 at a second depth (e.g., the blade bottom 430 spaced apart from the bottom 400 of the inner vessel 150 by a second distance 435). The second rotational movement can include the blade 200 of the second mixing blade 160B having a blade tip 205 rotating with a second blade tip speed. The second rotational movement can include the second mixing blade 160B rotating according to a second program or sequence (e.g., fluctuating speed over time, varying rotational direction over time, varying depth of the blade 200 over time, or varying over time in some other way). The second rotational movement of the second mixing blade 160B can be controlled or monitored by the computing system 185, for example.

The mixing system 100 can include the mixing element 500 to rotate with a third rotational movement. The mixing element 500 can move in a clockwise or anti-clockwise direction with the third rotational movement. The mixing element 500 can move at a third speed (e.g., rotational speed or velocity) with the third rotational movement. For example, in circumstances where the mixing element 500 includes the baffle 505, the third rotational movement of the mixing element 500 can be a movement of the baffle 505 within the chamber 145. The movement of the baffle 505 can be a movement along a circular path. The movement of the baffle 505 can be a movement of the baffle 505 along a circular path about a central axis (e.g., the axis 425) with the baffle 505 positioned proximate (e.g., within five centimeters, within two centimeters, within some other distance) of the inner wall 153 of the mixer vessel 135. The third rotational movement of the mixing element 500 can include a movement of the baffle 505 along a circular path in a clockwise direction or an anti-clockwise direction. The baffle 505 can move along a circular path at a third speed (e.g., rotational speed or velocity) with the third rotational movement. In circumstances where the mixing element 500 includes the rotating inner vessel 150, the third rotational movement can be a rotation of the inner vessel about the axis 425 with the inner vessel 150 positioned within the outer vessel 140. For example, the inner vessel 150 can rotate about a central axis (e.g., the axis 425) in a clockwise direction or an anti-clockwise direction with the third rotational movement. The inner vessel 150 can rotate about the central axis at third speed (e.g., rotational speed or velocity) with the third rotational movement. The third rotational movement of the mixing element 500 can be controlled or monitored by the computing system 185, for example.

The mixing system 100 can include the first rotational movement independent of at least one of the second rotational movement or the third rotational movement. For example, the first mixing blade 160A can rotate to mix the material within the chamber 145 independent of the second mixing blade 160B or the mixing element 500. The mixing system 100 can include each of the first mixing blade 160A, the second mixing blade 160B, the mixing element 500, or any other blade or mixing element to operate independently. The mixing system 100 can include each of the first mixing blade 160A, the second mixing blade 160B, the mixing element 500, or any other blade or mixing element to be controlled independently. For example, the first mixing blade 160A, the second mixing blade 160B, the mixing element 500, or any other blade or mixing element can be controlled by the computing system 185. The computing system 185 can operate the various blades or mixing elements independently, in sequence, according to separate programs, in parallel, in series, or in some other manner. For example, the computing system 185 can cause the first mixing blade 160A to rotate according to a first program or sequence, the second mixing blade 160B to rotate according to a second program or sequence, and the mixing element 500 to move according to a third program or sequence, where the first program or sequence, the second program or sequence, or the third program or sequence can be different or the same.

The mixing system 100 can include the first mixing blade 160A to rotate in a first direction with the first rotational movement and the second mixing blade 160B to rotate in a second direction with the second rotational movement, where the second direction and the first direction can be different. For example, the first direction in which the blade 200 of the first mixing blade 160A rotates and the second direction in which the blade 200 of the second mixing blade 160B rotates can be opposite directions. The first direction can be an anti-clockwise direction or a clockwise direction, and the second direction can be a clockwise direction or an anti-clockwise direction, respectively. The first direction of the first mixing blade 160A and the second direction of the second mixing blade 160B can vary over time. For example, the first direction of the first mixing blade 160A can be anti-clockwise and the second direction of the second mixing blade 160B can be clockwise at a first time interval, the first direction of the first mixing blade 160A can be clockwise and the second direction of the second mixing blade 160B can be anti-clockwise at a second time interval, and the same (e.g., both anti-clockwise or both clockwise) at a third time interval. The first direction and the second direction can be the same for an extended time interval (e.g., an entire mixing cycle), periodically, or for some other time interval.

The mixing system 100 can include the first mixing blade 160A to rotate at a first speed with the first rotational movement and the second mixing blade 160B to rotate at a second speed with the second rotational movement, where the second speed can be different than the first speed. For example, the first speed can be a first rotational speed, a first velocity, a first blade tip speed, a first acceleration, or a first torque of the first mixing blade 160A. The first speed of the first mixing blade 160A can be a first rotational speed, a first velocity, a first blade tip speed, a first acceleration, or a first torque of the blade 200 of the first mixing blade 160A, or a speed, velocity, acceleration, torque or other value associated with the shaft 165 of the first mixing blade 160A. The second speed can be a second rotational speed, a second velocity, a second blade tip speed, a second acceleration, or a second torque of the second mixing blade 160B. The second speed of the second mixing blade 160B can be a second rotational speed, a second velocity, a second blade tip speed, a second acceleration, or a second torque of the blade 200 of the second mixing blade 160B, or a speed, velocity, acceleration, torque or other value associated with the shaft 165 of the second mixing blade 160B. The first speed of the first mixing blade 160A can be different than the second speed of the second mixing blade 160B. For example, the first mixing blade 160A can include the blade 200 that rotates with a first blade tip speed with the first rotational movement that is greater than a second blade tip speed at which the blade 200 of the second mixing blade 160B rotates with the second rotational movement. The second mixing blade 160B can include the blade 200 that rotates at a second revolutions per minute with the second rotational movement that is greater than a first revolutions per minute at which the blade 200 of the first blade 200 rotates with the first rotational movement. The first speed of the first mixing blade 160A and the second speed of the second mixing blade 160B can vary over time. For example, the first speed of the first mixing blade 160A can be greater than the second speed of the second mixing blade 160B at a first time interval, less than the second speed of the second mixing blade 160B at a second time interval, and approximately equal to (e.g., ±95% equal) the second speed of the second mixing blade 160B at a third time interval. The first speed and the second speed can be the same or substantially the same (e.g., ±95% equal) for an extended time interval (e.g., an entire mixing cycle), periodically, or for some other time interval.

The mixing system 100 can include the first mixing blade 160A to rotate with the blade 200 at a first depth with the first rotational movement and the second mixing blade 160B to rotate with the blade 200 at a second depth with the second rotational movement, where the second depth can be different than the first depth. For example, the first mixing blade 160A and the second mixing blade 160B can include the blade 200 at a depth within the chamber 145, where the depth can be defined by a distance between the blade bottom 430 and the bottom 400 of the inner vessel 150. The first depth or the second depth can be defined in some other way (e.g., a distance from the top 420 of the outer vessel 140 to the blade 200). The first depth of the blade 200 of the first mixing blade 160A with the first rotational movement can be greater or less than the second depth of the blade 200 of the second mixing blade 160B with the second rotational movement. For example, the first depth can include the bottom 430 of the blade 200 of the first mixing blade 160A closer to the bottom 400 of the inner vessel 150 (e.g., having a smaller distance 435) than the bottom 430 of the blade 200 of the second mixing blade 160B is positioned relative to the bottom 400 of the inner vessel 150. The first depth of the first mixing blade 160A and the second depth of the second mixing blade 160B can vary over time. For example, the first depth of the first mixing blade 160A can be greater than the second depth of the second mixing blade 160B at a first time interval, less than the second depth of the second mixing blade 160B at a second time interval, and approximately equal to (e.g., ±95% equal) the second depth of the second mixing blade 160B at a third time interval.

The mixing system 100 can include the first mixing blade 160A to rotate in the first direction and at the first speed with the first rotational movement and the second mixing blade 160B to rotate in the second direction and at the second speed with the second rotational movement, where the second direction can be opposite the first direction and the second speed can be different than the first speed. For example, the first rotational movement of the first mixing blade 160A can include a first direction that is different than the second direction and a first speed that is different than the second speed. The first mixing blade 160A can move in a direction opposite a direction of the second mixing blade 160B while simultaneously rotating at a speed that is different than a speed of the second mixing blade 160B or while simultaneously rotating at a depth that is different than a depth of the second mixing blade 160B. For example, the first mixing blade 160A and the second mixing blade 160B can respectively include a first rotational movement and a second rotational movement that are independent (e.g., not dependent on each other, different, separately controlled, unrelated). The combination of the first rotational movement of the first mixing blade 160A and the second rotational movement of the second mixing blade 160B can create an interaction between the first mixing blade 160A and the second mixing blade 160B to facilitate mixing of the material within the chamber 145. For example, the mixing system 100 can mix material quicker, more efficiently, or more effectively with two independently-operated mixing blades 160 operating to mix the material within the chamber 145.

The mixing system 100 can include the first mixing blade 160A to rotate in a first direction with the first rotational movement and the mixing element 500 to rotate in a second direction with the third rotational movement, where the second direction and the first direction can be different. For example, the first direction in which the blade 200 of the first mixing blade 160A rotates and the second direction in which the mixing element 500 rotates can be opposite directions. The first direction can be an anti-clockwise direction or a clockwise direction, and the second direction can be a clockwise direction or an anti-clockwise direction, respectively. In circumstances where the mixing element 500 includes a baffle 505, the baffle 505 can move in a circular path within the chamber 145 in the second direction, where the second direction is opposite the first direction. In circumstances where the mixing element 500 includes the rotating inner vessel, the inner vessel 150 can rotate about a central axis (e.g., the axis 425) in the second direction, where the second direction is opposite the first direction. The first direction and the second direction can be the same for an extended time interval (e.g., an entire mixing cycle), periodically, or for some other time interval.

The mixing system 100 can include the first mixing blade 160A to rotate at a first speed with the first rotational movement and the mixing element 500 to rotate at a third speed with the third rotational movement, where the third speed can be different than the first speed. For example, the first speed can be a first rotational speed, a first velocity, a first blade tip speed, a first acceleration, or a first torque of the first mixing blade 160A. The first speed of the first mixing blade 160A can be a first rotational speed, a first velocity, a first blade tip speed, a first acceleration, or a first torque of the blade 200 of the first mixing blade 160A, or a speed, velocity, acceleration, torque or other value associated with the shaft 165 of the first mixing blade 160A. The third speed can be a third rotational speed, a third revolutions per minute, a third velocity, a third acceleration, or a third torque of the mixing element 500. The first speed of the first mixing blade 160A can be different than the third speed of the mixing element 500. The mixing element 500 can include the baffle 505 or the inner vessel 150 that rotates at a third revolutions per minute with the third rotational movement that is greater than a first revolutions per minute at which the blade 200 of the first blade 200 rotates with the first rotational movement. The first speed of the first mixing blade 160A and the third speed of the mixing element 500 can vary over time. For example, the first speed of the first mixing blade 160A can be greater than the third speed of the mixing element 500 at a first time interval, less than the third speed of the mixing element 500 at a second time interval, and approximately equal to (e.g., ±95% equal) the third speed of the mixing element 500 at a third time interval. The first speed and the third speed can be the same or substantially the same (e.g., ±95% equal) for an extended time interval (e.g., an entire mixing cycle), periodically, or for some other time interval.

The mixing system 100 can include the mixing element 500 including a first baffle 505 and a second baffle 505, the first baffle 505 extending into the chamber 145 and moving within the chamber 145 with the third rotational movement and the second baffle 505 extending into the chamber 145 and moving within the chamber 145 with a fourth rotational movement. For example, the first baffle 505 and the second baffle 505 can be the same or different. For example, the first baffle 505 can include different dimensions or a different shape than the second baffle 505. For example, the first baffle 505 can move within the chamber 145 along a path that differs from a path along which the second baffle 505 can move within the chamber 145. The first baffle 505 can move within the chamber 145 in a direction that differs from a direction in which the second baffle 505 can move within the chamber 145. The first baffle 505 can move within the chamber 145 at a speed that differs from a speed at which the second baffle 505 can move within the chamber 145. The first baffle 505 can be oriented at an angle relative to the inner wall 153 that differs from an angle at which the second baffle 505 is oriented with respect to the inner wall 153. The first baffle 505 can move independent from the second baffle 505. For example, the first baffle 505 and the second baffle 505 can be independently controlled by the computing system 185 or another device. The first baffle 505 can move within the chamber 145 according to a third program or sequence, and the second baffle 505 cam move within the chamber 145 according to a fourth program or sequence. The first baffle 505 and the second baffle 505 can move together according to the same rotational movement (e.g., the third rotational movement). For example, the first baffle 505 and the second baffle 505 can be operatively coupled such that the first baffle 505 and the second baffle 505 move together at the same speed, in the same direction, and according to the same program or sequence.

The mixing system 100 can include the first rotational movement of the first mixing blade 160A and second rotational movement of the second mixing blade 160B to create a high shear mixing zone 520 between the first mixing blade 160A and the second mixing blade 160B to mix the material. A zone (e.g., region, area, volume) of material between the blade 200 or the blade tip 205 of the first mixing blade 160A and the blade 200 or blade tip 205 of the second mixing blade 160B can exhibit or experience relatively high shear forces to mix, blend, disperse, knead, homogenize, dilute, or otherwise mix the material within the chamber 145. The high shear forces can be imparted to the material within the chamber 145 and can facilitate the mixing of the material. For example, the high shear forces can reduce an amount of time required to thoroughly or completely mix, blend, disperse, knead, homogenize, dilute, or otherwise mix a material within the chamber 145 relative to a mixing system that does not include high shear mixing zone. The small area between the blade 200 (e.g., the blade tip 205) of the first mixing blade 160A and the blade 200 (e.g., the blade tip 205) of the second mixing blade 160B, or the opposing directions of the first mixing blade 160A and the second mixing blade 160B according to the first and second rotational movements can facilitate the creation of the high shear mixing zone 520. For example, material can be mixed between the blade 200 of the first mixing blade 160A and the blade 200 of the second mixing blade 160B in a small (e.g., compact, tight) area and with the relative velocity of the first mixing blade 160A and the second mixing blade 160B because of the opposing rotational directions to create the high shear mixing zone 520. A difference in rotational speed between the first mixing blade 160A and the second mixing blade 160B can further increase or alter a magnitude of shearing forces imparted to the material in the high shear mixing zone 520. Other differences between the first rotational movement (e.g., rotational speed, depth of the blade 200, or a first program or sequence) and the second rotational movement (e.g., rotational speed, depth of the blade 200, or a second program or sequence) can facilitate the creation of the high shear mixing zone 520 to mix (e.g., blend, disperse, knead, homogenize, disperse, or otherwise mix) the material.

The mixing system 100 can include the first rotational movement of the first mixing blade 160A and the third rotational movement of the mixing element 500 to create a high shear mixing zone 520 between the first mixing blade 160A and the inner vessel 150 to mix the material. For example, the first rotational movement of the first mixing blade 160A and the third rotational movement of the rotating inner vessel 150 can create a high shear mixing zone 520 between the first mixing blade 160A and the inner vessel 150 to mix the material. A zone (e.g., region, area, volume) of material between the blade 200 or the blade tip 205 of the first mixing blade 160A and the inner wall 153 of the inner vessel 150 can exhibit or experience relatively high shear forces to mix, blend, disperse, knead, homogenize, dilute, or otherwise mix the material within the chamber 145. The small area between the blade 200 (e.g., the blade tip 205) and the inner wall 153 of the inner vessel 150 or the opposing directions of the first mixing blade 160A and the inner vessel 150 according to the first and third rotational movements can facilitate the creation of a high shear mixing zone 520. For example, material can be mixed between the blade 200 and the inner wall 153 of the inner vessel 150 in a small (e.g., compact, tight) area and with the relative velocity of the inner vessel 150 and blade 200 magnified because of the opposing rotational directions. A difference in rotational speed between the first mixing blade 160A and the inner vessel 150 can further increase or alter a magnitude of shearing forces imparted to the material in the high shear mixing zone 520. Other differences between the first rotational movement (e.g., rotational speed, depth of the blade, or a first program or sequence) and the third rotational movement (e.g., rotational speed, a third program or sequence) can facilitate the creation of the high shear mixing zone 520 to mix (e.g., blend, disperse, knead, homogenize, disperse, or otherwise mix) the material.

The mixing system 100 can include the first rotational movement of the first mixing blade 160A and the third rotational movement of the mixing element 500 to create a high shear mixing zone 520 between the first mixing blade 160A and the baffle 505 to mix the material. A zone (e.g., region, area, volume) of material between the blade 200 or the blade tip 205 of the first mixing blade 160A and baffle 505 can exhibit or experience relatively high shear forces to mix, blend, disperse, knead, homogenize, dilute, or otherwise mix the material within the chamber 145. The small area between the blade 200 (e.g., the blade tip 205) and the baffle 505 of the mixing element 500 can facilitate the creation of the high shear mixing zone 520. The opposing directions of the first mixing blade 160A and the baffle 505 according to the first and third rotational movements can facilitate the creation of the high shear mixing zone 520. For example, material can be mixed between the blade 200 and the baffle 505 in a small (e.g., compact, tight) area and with the relative velocity of the inner vessel 150 and blade 200 magnified because of the opposing rotational directions. A difference in rotational speed between the first mixing blade 160A and the baffle 505 can further increase or alter a magnitude of shearing forces imparted to the material in the high shear mixing zone 520. Other differences between the first rotational movement (e.g., rotational speed, depth of the blade, or a first program or sequence) and the third rotational movement (e.g., rotational speed, a third program or sequence) of the baffle 505 can facilitate the creation of the high shear mixing zone 520 to mix (e.g., blend, disperse, knead, homogenize, disperse, or otherwise mix) the material.

The mixing system 100 can include the second rotational movement of the second mixing blade 160B and the third rotational movement of the mixing element 500 to create at least one medium shear mixing zone 525 between the second mixing blade 160B and the mixing element 500. For example, the second rotational movement of the second mixing blade 160B and the third rotational movement of the rotating inner vessel 150 or the baffle 505 can create a medium shear mixing zone 525 between the second mixing blade 160B and the inner vessel 150 or the baffle 505 to mix the material. A zone (e.g., region, area, volume) of material between the blade 200 or the blade tip 205 of the second mixing blade 160B and the inner wall 153 of the inner vessel 150 or the baffle 505 can exhibit or experience shear forces to mix, blend, disperse, knead, homogenize, dilute, or otherwise mix the material within the chamber 145. The medium shear forces can be imparted to the material within the chamber 145 and can facilitate the mixing of the material. The small area between the blade 200 (e.g., the blade tip 205) and the inner wall 153 of the inner vessel 150 or the opposing directions of the second mixing blade 160B and the inner vessel 150 or the baffle 505 according to the second and third rotational movements can facilitate the creation of the medium shear mixing zone 525. The medium shear forces of the medium shear mixing zone 525 can include shear forces that are relatively smaller (e.g., lower in magnitude) than high shear forces in the high shear mixing zone 520. For example, the material can be mixed between the blade 200 and the baffle 505 or the inner wall 153 of the inner vessel 150 in a small (e.g., compact, tight) area, but the second mixing blade 160B and the mixing element 500 can both rotate in the same direction (e.g., the second direction) according to the second rotational movement and the third rotational movement. The medium shear mixing zone 525 can include material moved through a small area, but without opposing rotational directions, for example.

The medium shear mixing zone 525 can be created within the material in the chamber 145 as the baffle 505 or inner vessel 150 rotates. For example, the medium shear mixing zone 525 can be created as the baffle 505 approaches the second mixing blade 160B. The medium shear mixing zone 525 can be created as the baffle 505 departs from the second mixing blade 160B. For example, the medium shear mixing zone 525 can extend around the second mixing blade 160B (e.g., in regions or areas other than the region directly between the second mixing blade and the inner wall 153). The medium shear mixing zone 525 can extend around the second mixing blade 160B except for the region directly between the first mixing blade 160A and the second mixing blade 160B, where the high shear mixing zone 520 can be exist instead. The medium shear mixing zone 525 can also exist between the high shear mixing zone 520 (e.g., the high shear mixing zone 520 between the first mixing blade 160A and the second mixing blade 160B) and the inner vessel 150 or the baffle 505. For example, the high shear mixing zone 520 can transition to a medium shear mixing zone 525 in regions positioned farther from the high shear mixing zone 520.

A difference in rotational speed between the second mixing blade 160B and the inner vessel 150 or baffle 505 can further increase or alter a magnitude of shearing forces imparted to the material in the medium shear mixing zone 525. Other differences between the second rotational movement (e.g., rotational speed, depth of the blade, or a first program or sequence) and the third rotational movement (e.g., rotational speed, a third program or sequence) can facilitate the creation of the medium shear mixing zone 525 to mix (e.g., blend, disperse, knead, homogenize, disperse, or otherwise mix) the material.

The mixing system 100 can include the third rotational movement of the mixing element 500 to create at least one low shear mixing zone 530 at the inner wall 153. For example, the mixing element 500 create the low shear mixing zone 530 as the baffle 505 or inner vessel 150 rotate with the third rotational movement. As depicted in FIGS. 5 and 6, among others, one or more low shear mixing zones 530 can exist in areas or regions of the material within the chamber 145 that are located away from the first mixing blade 160A or the second mixing blade 160B. For example, the low shear mixing zone 530 can be created in a region of the material where the material is not being actively mixed by either the first mixing blade 160A or the second mixing blade 160B. The low shear mixing zone 530 can be created in a region of the material where the material is only being actively mixed by the mixing element 500, such as by the baffle 505 or the rotating inner vessel 150 according to the third rotational movement. The low shear mixing zone 530 can exhibit or experience shear forces to mix, blend, disperse, knead, homogenize, dilute, or otherwise mix the material within the chamber 145. The low shear mixing zone 530 can include relatively low shear forces that can be imparted to the material within the chamber 145 and can facilitate the mixing of the material. The low shear forces of the low shear mixing zone 530 can include shear forces that are relatively smaller (e.g., lower in magnitude) than high shear forces in the high shear mixing zone 520 or the medium shear forces of the medium shear mixing zone 525. Though the shear forces in the low shear mixing zone 530 can be relatively low (e.g., less than other shear forces imparted to the material within the chamber 145), the shear forces of the low shear mixing zone 530 can facilitate the mixing (e.g., blending, dispersing, kneading, homogenizing, diluting) of the material within the chamber 145.

The medium shear mixing zone 525 can be or include a combination of at least one high shear mixing zone 520 and at least one low shear mixing zone 530. For example, the medium shear mixing zone 525 can include high shear forces associated with at least one high shear mixing zone 520 created by a movement of the first mixing blade 160A, the second mixing blade 160B, the mixing element 500, or some interaction thereof. The medium shear mixing zone 525 can include low shear forces associated with at least one low shear mixing zone 530 created by a movement of the first mixing blade 160A, the second mixing blade 160B, the mixing element 500, or some interaction thereof. The medium shear mixing zone 525 can be dynamic or adjustable based on a variation in the high shear mixing zone 520 or the low shear mixing zone 530. For example, at least one of the first mixing blade 160A, the second mixing blade 160B, the mixing element 500, or some other mixing device can be adjusted (e.g., a speed adjusted, a direction changed) to increase or decrease a magnitude of a shear force within the high shear mixing zone 520 or a shear force within the low shear mixing zone 530. The adjustment of the shear force of the high shear mixing zone 520 or the shear force of the low shear mixing zone 530 can cause a change in a magnitude of a shear force of the medium shear mixing zone 525. For example, the medium shear mixing zone 525 can be control (e.g., increased, decreased, or otherwise altered) by altering the high shear mixing zone 520 or the low shear mixing zone.

The mixing system 100 can include the first mixing blade 160A, the second mixing blade 160B, or the mixing element 500 to eliminate or substantially eliminate (e.g., eliminate 90% or more) dead zones within the chamber 145 of the mixer vessel 135. For example, the mixing system 100 can include the first rotational movement of the first mixing blade 160A, the second rotational movement of the second mixing blade 160B, and the third rotational movement of the mixing element 500 to mix materials within the chamber 145 without or substantially without zones where no mixing is occurring. For example, the materials within the mixer vessel 135 can be mixed in a low shear mixing zone 530, a medium shear mixing zone 525, a high shear mixing zone 520, or some other mixing zone such that the materials throughout the chamber 145 are exposed to shear forces of some magnitude. The mixing system 100 can mix the materials such that there are no zones, areas, regions, or portions of the materials within the mixer vessel 135 that are not exposed to shear forces. The mixing system 100 can mix materials within the chamber 145 in an efficient manner (e.g., achieve a particular degree of homogeneity quicker than a mixing system not having the first mixing blade 160A, the second mixing blade 160B, or the mixing element 500) by eliminating or substantially eliminating dead zones.

The mixing system 100 can mix the materials with the materials having a high slurry viscosity. For example, the mixing system 100 as discussed herein can be used to mix the materials having a relatively high slurry viscosity, such 2,500 cPs, 5,000-25,000 cPs, or greater than 25,000 cPs, or some other viscosity. The material can have a high solid content (e.g., 60%-70% solid content by weight or some other solid content), a relatively low solvent content, or both a relatively high solid content and a relatively low solvent content. The slurry viscosity of the materials can require a shear force to mix the materials to create a homogenous or substantially homogeneous (e.g., ±greater than 80% homogenous, greater than 90% homogeneous, greater than 95% homogeneous, greater than 98% homogeneous, or some other degree of homogeneity) mixture. The mixing system 100 can include the first mixing blade 160A, the second mixing blade 160B, and the mixing element 500 to create a high shear mixing zone 520, a medium shear mixing zone 525, or a low shear mixing zone 530 to mix the materials having the high slurry viscosity. For example, the high shear mixing zone 520 generated by the first mixing blade 160A, the second mixing blade 160B, or the mixing element 500 can include shear forces that equal to or greater than the shear force required to mix the materials to create the homogenous or substantially homogeneous mixture. For example, because the mixing system 100 can create the high shear mixing zone 520, the medium shear mixing zone 525, the low shear mixing zone 530, or another mixing zone to successfully mix materials having a high viscosity resulting from either a high solid content, a low solvent content, or some other characteristic.

For example, the mixing system 100 can mix the materials having the high slurry viscosity to produce a slurry for electrodes (e.g., the anode electrode 2215 or the cathode electrode 2225 discussed below and shown in FIG. 22, among others), where the slurry can have a reduced solvent content. The slurry can have a reduced solvent content to reduce material costs associated with the solvent or to improve a manufacturing throughput by reducing solvent abatement operations or by reducing a required drying time. The slurry can have a reduced solvent content to reduce or eliminate an abatement system required for handling or disposing of toxic solvents such as NMP, which can reducing a required manufacturing footprint to produce the electrode. The slurry can have a reduced solvent content to reduce an energy requirement or a duration of a downstream drying operation to remove the solvent when drying the coated electrode substrates. The mixing system 100 can include the first mixing blade 160A, the second mixing blade 160B, the mixing element 500, or some other element to mix materials having the high slurry viscosity in an efficient and effective manner.

FIGS. 7-17, among others, depict blades 200, 800, 900, 1000, 1100, 1200, 1300, 1400, 1500, 1600, and 1700. The blades 200, 800, 900, 1000, 1100, 1200, 1300, 1400, 1500, 1600, and 1700 can be used with the first mixing blade 160A, the second mixing blade 160B, or another mixing blade. For example, one or more of the blades 200, 800, 900, 1000, 1100, 1200, 1300, 1400, 1500, 1600, and 1700 can be detachably coupled with the shaft 165 of the first mixing blade 160A or the second mixing blade 160B to mix a material within the chamber 145 of the mixing system 100. Each of the blades 200, 800, 900, 1000, 1100, 1200, 1300, 1400, 1500, 1600, and 1700 can include a geometry, dimension, or other feature to facilitate mixing. For example, each of the blades 200, 800, 900, 1000, 1100, 1200, 1300, 1400, 1500, 1600, and 1700 can include a particular geometry, dimension, or other feature to facilitate mixing of a particular material or materials within the chamber 145, such as a cathode material to produce a cathode electrode, an anode material to produce an anode electrode, or otherwise.

FIG. 7, among others, depicts the blade 200. The blade 200 can include at least one blade tip 205. As discussed above, the blade tip 205 can extend radially from the shaft 165 to which the blade 200 can be coupled. The blade tip 205 can extend some other direction from the blade 200. For example, the blade tip 205 can extend outward from the blade 200 in a direction having a horizontal component (e.g., perpendicular to the shaft 165) and a vertical component. The blade tip 205 can include a projection (e.g., extending member, peg, shaft, rod) extending in a vertical direction (e.g., a direction parallel with the shaft 165 of the mixing blade 160). The blade 200 can included the blade tip 205 extending horizontally with the projection extending vertically therefrom. The blade 200 can include six blade tips 205, fewer than six blade tips 205, or more than six blade tips 205.

FIG. 8, among others, depicts a blade 800. The blade 800 can include at least one blade tip 805. The blade tip 805 can extend radially from the shaft 165 to which the blade 800 can be coupled. The blade tip 805 can extend in some other direction from the blade 800. For example, the blade tip 805 can extend outward from the blade 800 in a direction having a horizontal component (e.g., perpendicular to the shaft 165) and a vertical component. The blade 800 can be coupled with the shaft 165 of the mixing blade 160 to be used in place of or in addition to the blade 200 discussed herein. The blade tip 805 can extend from the blade 800 in a loop-type pattern or configuration such that an opening 810 can be defined within the blade tip 805. For example, rather than being solid (e.g., without internal passages), the blade tip 805 can include at least one opening 810 through which material can pass as the blade 800 rotates within material (e.g., material within the chamber 145). The blade 800 can include two blade tips 805, three blade tips 805, or some other number of blade tips 805.

FIG. 9, among others, depicts a blade 900. The blade 900 can include at least one blade tip 905. The blade tip 905 can extend radially from the shaft 165 to which the blade 900 can be coupled. The blade tip 905 can extend some other direction from the blade 900. For example, the blade tip 905 can extend outward from the blade 900 in a direction having a horizontal component (e.g., perpendicular to the shaft 165) and a vertical component. The blade 900 can be coupled with the shaft 165 of the mixing blade 160 to be used in place of or in addition to the blade 200 discussed herein. The blade 900 can include the blade tips 905 angled such that a top edge of the blade tip 905 is offset from or positioned in front of or behind a bottom edge of the blade tip 905. The angle of the blade tip 905 can be adjustable. The blade tip 905 can include a rectangular shape or some other shape. The blade tip 905 can include a rectangular cross-sectional shape, an arcuate cross-sectional shape, or some other cross-sectional shape. For example, the blade tip 905 can be curved, bowed, or flexed.

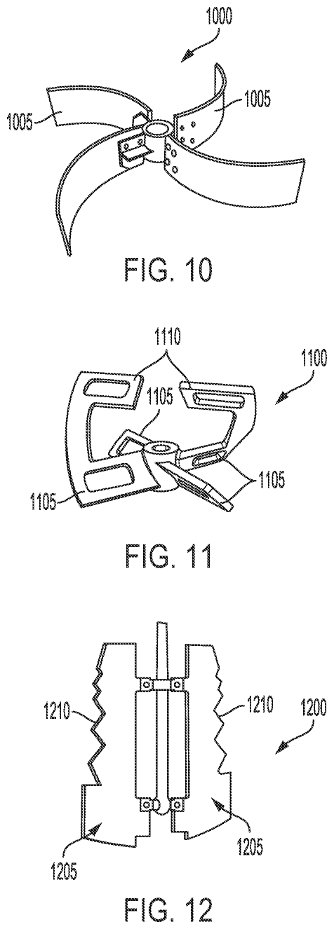

FIG. 10, among others, depicts a blade 1000. The blade 1000 can include at least one blade tip 1005. The blade tip 1005 can extend radially from the shaft 165 to which the blade 1000 can be coupled. The blade tip 1005 can extend some other direction from the blade 1000. For example, the blade tip 1005 can extend outward from the blade 1000 in a direction having a horizontal component (e.g., perpendicular to the shaft 165) and a vertical component. The blade 1000 can be coupled with the shaft 165 of the mixing blade 160 to be used in place of or in addition to the blade 200 discussed herein. The blade 1000 can include the blade tip 1005 having a curved shape. For example, the blade tip 1005 can be curved from a medial end (e.g., an inner end, an end coupled with the blade 1000) towards a distal end (e.g., an outer end, an end extending away from the blade 1000). The blade tip 1005 can include a bowed shape that can be convex or concave with respect to a direction in which the blade 1000 rotates. The blade tip 1005 can include a rectangular shape or some other shape. The blade tip 1005 can include a rectangular cross-sectional shape, an arcuate cross-sectional shape, or some other cross-sectional shape. For example, the blade tip 1005 can be curved, bowed, or flexed from a top edge of the blade tip 1005 to a bottom edge of the blade tip 1005.

FIG. 11, among others, depicts a blade 1100. The blade 1100 can include at least one blade tip 1105. The blade tip 1105 can extend radially from the shaft 165 to which the blade 1100 can be coupled. The blade tip 1105 can extend some other direction from the blade 1100. For example, the blade tip 1105 can extend outward from the blade 1100 in a direction having a horizontal component (e.g., perpendicular to the shaft 165) and a vertical component. The blade 1100 can be coupled with the shaft 165 of the mixing blade 160 to be used in place of or in addition to the blade 200 discussed herein. The blade tip 1105 can include at least one auxiliary blade tip 1110. For example, one or more of the blade tips 1105 can include an auxiliary blade tip 1110 extending therefrom. As depicted in FIG. 11, among others, the blade tip 1105 can extend radially from the blade 1100. The auxiliary blade tip 1110 can extend from the blade tip 1105 in some other direction, such as a vertical direction (e.g., a direction parallel with the shaft 165), or a direction having a vertical component (e.g., a direction extending radially from the blade 1100 and vertically from the blade tip 1105. The auxiliary blade tip 1110 can facilitate a mixing of the material within the chamber 145. For example, the auxiliary blade tip 1110 can cause the blade 1100 to mix material above or below the blade tip 1105 in addition to mixing material at or proximate to (e.g., in a same plane as) the blade tip 1105. The auxiliary blade tip 1110 can facilitate the creation of high shear forces, medium shear forces, or low shear forces as the blade 1100 rotates to mix the material. The blade tip 1105 or the auxiliary blade tip 1110 can include a curved, arcuate, concave, convex, or irregular shape.

FIG. 12, among others, depicts a blade 1200. The blade 1200 can include at least one blade tip 1205. The blade tip 1205 can extend radially from the shaft 165 to which the blade 1200 can be coupled. The blade tip 2105 can extend some other direction from the blade 1200. For example, the blade tip 1205 can extend outward from the blade 1200 in a direction having a horizontal component (e.g., perpendicular to the shaft 165) and a vertical component. The blade 1200 can be coupled with the shaft 165 of the mixing blade 160 to be used in place of or in addition to the blade 200 discussed herein. The blade tip 1205 can be oriented vertically such that an inner edge of the blade tip 1205 (e.g., an edge coupled with the shaft 165 is parallel or substantially parallel (e.g., ±150 from parallel) with the shaft 165). The blade tip 1205 can include an outer edge 1210. The outer edge 1210 can be jagged or include an irregular shape. For example, the outer edge 1210 can include projections, protrusions, ridges, or portions extending outward from the blade tip 1205. The outer edge 1210 can be jagged or irregularly shaped to increase a turbulence of a material being mixed by the blade 1200 (e.g., the material within the chamber 145). For example, the outer edge 1210 can impart high shear forces, medium shear forces, or low shear forces into the material as the blade 1200 rotates within the chamber.

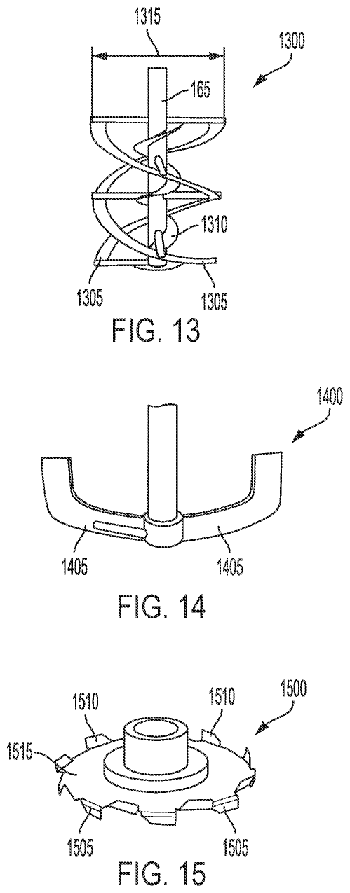

FIG. 13, among others, depicts a blade 1300. The blade 1300 can include at least one outer blade 1305 and at least one inner blade 1310. The outer blade 1305 and the inner blade 1310 can include a helical shape that can coil (e.g., wrap) around the shaft 165 of the mixing blade 160. The outer blade 1305 can include a helical shape having a diameter 1315 that is greater than a diameter of the shaft 165. The outer blade 1305 can include a width or thickness that is less than a radius (e.g., less than half of the diameter 1315) of the outer blade 1305 such that a space exists between the shaft 165 and the outer blade 1305. The outer blade 1305 can be periodically coupled with the shaft 165 via horizontal or radially-extending members. The inner blade 1310 can include a helical shape having a diameter that is less than the diameter 1315 of the outer blade 1305 such that the inner blade 1310 wraps around the shaft 165 with the inner blade 1310 positioned within the space between the outer blade 1305 and the shaft 165. The inner blade 1310 can be coupled with the shaft 165 along the entire length or a substantial portion (e.g., ±80%) of the inner blade 1310. The inner blade 1310 can have a pitch that is different than or the same as the outer blade 1305. The blade 1300 can include two diametrically opposed outer blades 1305. For example, the two outer blades 1305 can form a double helix shape.

FIG. 14, among others, depicts a blade 1400. The blade 1400 can include at least one blade tip 1405. The blade tip 1405 can extend radially from the blade 1400. The blade tip 1405 can extend some other direction from the shaft 165 to which the blade 1400 can be coupled. For example, the blade tip 1405 can extend outward from the blade 1400 in a direction having a horizontal component (e.g., perpendicular to the shaft 165) and a vertical component. The blade 1400 can be coupled with the shaft 165 of the mixing blade 160 to be used in place of or in addition to the blade 200 discussed herein. The blade tip 1405 can extend in curved shape from the shaft 165 of the blade 1400. For example, the blade tip 1405 can extend horizontally (e.g., radially) from the shaft 165 before bending in a vertical direction (e.g., upwards). The blade 1400 can include two diametrically opposed blade tips 1405 that collectively form a U-shape. The blade tip 1405 can lie flat within a vertical plane. For example, the blade tip 1405 can include a rectangular cross-sectional shape.

FIG. 15, among others, depicts a blade 1500. The blade 1500 can include at least one lower blade tip 1505, at least one upper blade tip 1510, and a body portion 1515. The body portion 1515 can be a disc that extends radially from the shaft 165. The lower blade tip 1505 can extend downwards or partially downwards in a vertical direction from the body portion 1515. The upper blade tip 1510 can extend upwards or partially upwards in a vertical direction from the body portion 1515. For example, the body portion 1515 can be a disc centered on a central axis of the shaft 165 (e.g., the axis 450 or 455) and positioned in a horizontal plane. Multiple upper blade tips 1510 and lower blade tips 1505 can extend in a vertical direction from a perimetral edge of the body portion 1515. For example, lower blade tips 1505 and the upper blade tips 1510 can alternate along the perimetral edge of the body portion 1515. The upper blade tips 1510 and lower blade tips 1505 can extend around the entire perimeter of the body portion 1515 or around a portion of the body portion 1515. The blade 1500 can be coupled with the shaft 165 of the mixing blade 160 to be used in place of or in addition to the blade 200 discussed herein.

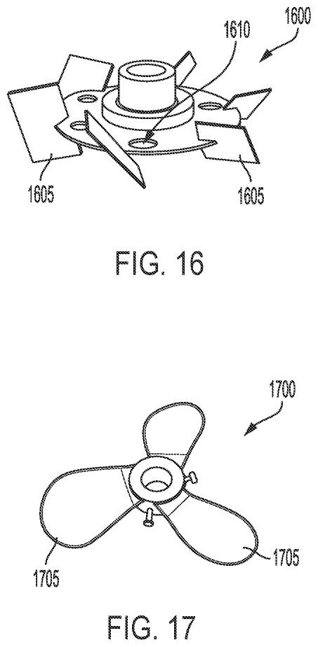

FIG. 16, among others, depicts a blade 1600. The blade 1600 can include at least one blade tip 1605 and at least one body portion 1610. The body portion 1610 can be a disc or some other generally planar member that extends in a horizontal plane. For example, the body portion 1610 can be a disc centered on a central axis of the shaft 165 (e.g., the axis 450 or 455) and positioned in a horizontal plane. One or more blade tips 1605 can be coupled with and can extend from the body portion 1610. For example, the blade tip 1605 can extend in a vertical direction or in some direction at an angle with respect to the horizontal plane in which the body portion 1610 can be positioned. The blade tip 1605 can be at a 30 degree angle, 60 degree angle, or at some other angle with respect to the horizontal plane in which the body portion 1610 is positioned. The blade tip 1605 can be a flat, curved, or irregularly shaped member. The blade 1600 can be coupled with the shaft 165 of the mixing blade 160 to be used in place of or in addition to the blade 200 discussed herein.

FIG. 17, among others, depicts a blade 1700. The blade 1700 can include at least one blade tip 1705. The blade tip 1705 can extend radially from the shaft 165 to which the blade 1700 can be coupled. The blade tip 1705 can extend some other direction from the blade 1700. For example, the blade tip 1705 can extend outward from the blade 1700 in a direction having a horizontal component (e.g., perpendicular to the shaft 165) and a vertical component. The blade 1700 can be coupled with the shaft 165 of the mixing blade 160 to be used in place of or in addition to the blade 200 discussed herein. The blade 1700 can include the blade tip 1705 having a curved shape. For example, the blade tip 1705 can be curved from a medial end (e.g., an inner end, an end coupled with the shaft 165) towards a distal end (e.g., an outer end, an end extending away from the shaft 165). The blade tip 1705 can be curved in a vertical direction, a horizontal direction, or in me other direction. For example, the blade tip 1705 can include three-dimensional curvature (e.g., curvature in three dimensions). The blade tip 1705 can include a propeller-like shape. The blade tip 1705 can include a rounded or smooth edge, rather than a sharp or pointed distal edge.

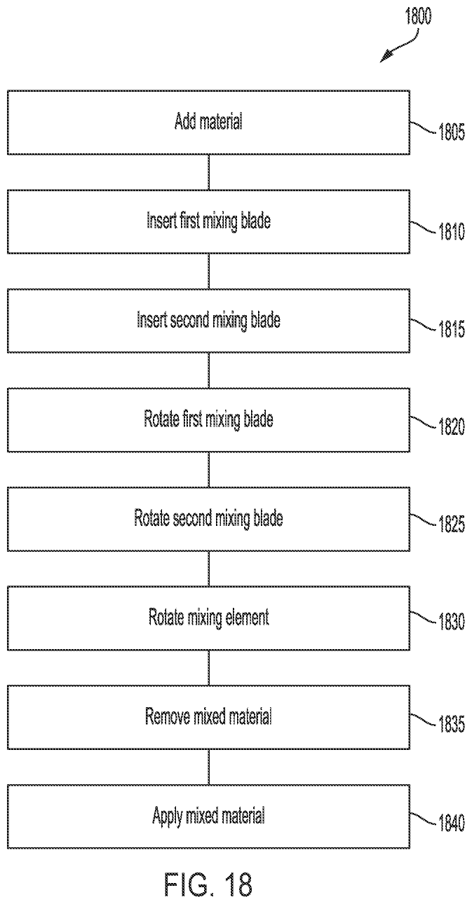

FIG. 18, among others, depicts a flow chart of a method 1800. The method 1800 can be a method of mixing a material or a method of manufacturing an electrode. For example, the method 1800 can be or include method of mixing an electrode material (e.g., an anode material or a cathode material) that can be applied to a current collector foil (e.g., a copper or aluminum foil) to create an electrode for a battery (e.g., a lithium-ion battery or some other type of battery). The method 1800 can include one or more of ACTS 1805-1840. The method 1800 can include one or more of the ACTS 1805-1840 performed in any order.

The method 1800 can include adding a material at ACT 1805. For example, the method 1800 can include adding one or more materials to the chamber 145 of the mixing system 100 at ACT 1805. The material can be provided to the chamber 145 of the mixing system 100 so that the material can be mixed (e.g., blended, dispersed, kneaded, homogenized, diluted, or otherwise mixed) by the mixing system 100. The material can be added to the chamber 145 of the mixing system by an injector or injection mechanism of the mixing system 100. For example, the mixer vessel 135 of the mixing system 100 can include at least one injection mechanism (e.g., fluid conduit, valve-controlled flow passageway, or some other mechanism to provide solid, liquid, semi-solid, dry, semi-dry, semi-wet, or mixture of materials to the chamber 145. The method 1800 can include providing multiple materials to the chamber 145 at ACT 1805. For example, the method 1800 can include adding a solid material (e.g., a battery active material in powdered form, a carbon material, a binder material, or some other material), a liquid material (e.g., a solvent, a catalyst, a liquid binding agent, or some other liquid), or some other material to the chamber 145, where each of the added materials can be mixed by the mixing system 100 to create a blended (e.g., mixed, dispersed, kneaded, homogenized, diluted, or otherwise blended) or substantially blended (e.g., ±95% blended) material.

The method 1800 can include inserting a first mixing blade at ACT 1810. For example, the method 1800 can include inserting the first mixing blade 160A into the chamber 145 at ACT 1810. The method 1800 can include inserting the first mixing blade 160A into the chamber 145 with the material already added to the chamber 145 at ACT 1805, before the material is added to the chamber 145, or as the material is added to the chamber 145. The first mixing blade 160A can extend from the gearbox 170 of the mixing system 100 and into the chamber 145 of the mixer vessel 135 via an open end of the mixer vessel 135. For example, the first mixing blade 160A can extend from the gearbox 170 into the chamber 145 in a vertical (e.g., downwards) direction. The first mixing blade 160A can be inserted into the chamber 145 such that a blade 200 of the first mixing blade 160A can be at a certain depth within the chamber 145 or at a certain depth within the material occupying the chamber 145. For example, the first mixing blade 160A can be inserted into the chamber 145 such that the bottom 430 of the blade 200 can be spaced apart from the bottom 400 of the inner vessel 150 or some other surface (e.g., the bottom 410 of the outer vessel 140, an upper surface of the material within the chamber 145, or some other surface) by the distance 435.

The method 1800 can include inserting a second mixing blade at ACT 1815. For example, the method 1800 can include inserting the second mixing blade 160B into the chamber 145 at ACT 1815. The method 1800 can include inserting the second mixing blade 160B into the chamber 145 with the material already added to the chamber 145 at ACT 1805, before the material is added to the chamber 145, or as the material is added to the chamber 145. The second mixing blade 160B can extend from the gearbox 170 of the mixing system 100 and into the chamber 145 of the mixer vessel 135 via an open end of the mixer vessel 135. For example, the second mixing blade 160B can extend from the gearbox 170 into the chamber 145 in a vertical (e.g., downwards) direction. The second mixing blade 160B can be inserted into the chamber 145 such that a blade 200 of the second mixing blade 160B can be at a certain depth within the chamber 145 or at a certain depth within the material occupying the chamber 145. For example, the first mixing blade 160A can be inserted into the chamber 145 such that the bottom 430 of the blade 200 can be spaced apart from the bottom 400 of the inner vessel 150 or some other surface (e.g., the bottom 410 of the outer vessel 140, an upper surface of the material within the chamber 145, or some other surface) by the distance 435.

The method 1800 can include rotating the first mixing blade at ACT 1820. For example, the method 1800 can include rotating the first mixing blade 160A according to a first rotational movement with the first mixing blade 160A extending into the chamber 145 or into the material occupying the chamber 145. The first rotational movement can include the first mixing blade 160A rotating in a first direction, at a first speed, and at a first depth (e.g., with the blade 200 spaced apart from the bottom 400 of the inner vessel 150 by the distance 435), or according to a first program or sequence. For example, the first mixing blade 160A can rotate with the blade 200 positioned within the chamber 145 of the mixer vessel 135 and at least partially submerged in the material occupying the chamber 145 to mix (e.g., blend, disperse, knead, homogenize, dilute, or otherwise mix) the material. The rotation of the blade 200 according to the first rotational movement or some other rotational movement with the blade 200 submerged in the material can cause the material to mix until a homogenized or substantially homogenized (e.g., ±greater than 80% homogenized, greater than 90% homogenized, greater than 95% homogenized, greater than 98% homogenized, or some other degree of homogeneity) material results. The first rotational movement of the first mixing blade 160A can be independent from rotational movements of other components (e.g., the second mixing blade 160B or the mixing element 500). The rotation of the first mixing blade 160A according to the first rotational movement or some other rotational movement within the chamber 145 can create a high shear mixing zone 520, a medium shear mixing zone 525, or a low shear mixing zone 530 within the material occupying the chamber 145 to mix the material.

The method 1800 can include rotating the second mixing blade at ACT 1825. For example, the method 1800 can include rotating the second mixing blade 160B according to a second rotational movement with the second mixing blade 160B extending into the chamber 145 or into the material occupying the chamber 145. The second rotational movement can include the second mixing blade 160B rotating in a second direction, at a second speed, and at a second depth (e.g., with the blade 200 spaced apart from the bottom 400 of the inner vessel 150 by the distance 435), or according to a second program or sequence. For example, the second mixing blade 160B can rotate with the blade 200 positioned within the chamber 145 of the mixer vessel 135 and at least partially submerged in the material occupying the chamber 145 to mix (e.g., blend, disperse, knead, homogenize, dilute, or otherwise mix) the material. The rotation of the blade 200 according to the second rotational movement or some other rotational movement with the blade 200 submerged in the material can cause the material to mix until a homogenized or substantially homogenized (e.g., ±greater than 80% homogenized, greater than 90% homogenized, greater than 95% homogenized, greater than 98% homogenized, or some other degree of homogeneity) material results. The second rotational movement of the second mixing blade 160B can be independent from rotational movements of other components (e.g., the first mixing blade 160A or the mixing element 500). The rotation of the second mixing blade 160B according to the second rotational movement or some other rotational movement within the chamber 145 can create a high shear mixing zone 520, a medium shear mixing zone 525, or a low shear mixing zone 530 within the material occupying the chamber 145 to mix the material. The rotation of the second mixing blade 160B and the rotation of the first mixing blade 160A can mix the material in an expedient, efficient, and effective manner such that the material within the chamber 145 is mixed or substantially mixed (e.g., ±95% mixed) in a shorter amount of time or with greater efficacy than a mixing system that does not include the first mixing blade 160A rotating with the first rotational movement and the second mixing blade 160B rotating with the second rotational movement.

The method 1800 can include rotating a mixing element at ACT 1830. For example, the method 1800 can include rotating the mixing element 500 according to a third rotational movement to mix the material occupying the chamber 145. The mixing element 500 can include the baffle 505 (e.g., two baffles 505) extending into the material or the inner vessel 150 of the mixer vessel 135. The third rotational movement can include the third mixing blade 160 rotating in a third direction, at a third speed, according to a third program or sequence, or otherwise. In circumstances where the mixing element 500 is the baffle 505, the third rotational movement can include the baffle 505 rotating within the chamber 145 in a circular path proximate (e.g., within five centimeters of, within two centimeters of, or within some other distance of) the inner wall 153, where the path can be circular about a central axis of the mixer vessel 135 (e.g., the axis 425) with the third rotational movement. In circumstances where the mixing element 500 is a rotating inner vessel 150, the inner vessel 150 can rotate within the outer vessel 140, where the chamber 145 is within the inner vessel 150. For example, the inner vessel 150 can rotate about a central axis (e.g., the axis 425) with the third rotational movement. For example, the mixing element 500 can rotate with the third rotational movement to mix (e.g., blend, disperse, knead, homogenize, dilute, or otherwise mix) the material within the chamber 145. The rotation of the baffle 505 or the inner vessel 150 according to the third rotational movement or some other rotational movement can cause the material to mix until a homogenized or substantially homogenized (e.g., ±greater than 80% homogenized, greater than 90% homogenized, greater than 95% homogenized, greater than 98% homogenized, or some other degree of homogeneity) material results. The third rotational movement of the mixing element can be independent from rotational movements of other components (e.g., the first mixing blade or the second mixing blade 160B). The rotation of the mixing element 500 according to the third rotational movement or some other rotational movement within the chamber 145 can create a high shear mixing zone 520, a medium shear mixing zone 525, or a low shear mixing zone 530 within the material occupying the chamber 145 to mix the material. The rotation of the mixing element 500, the rotation of the second mixing blade 160B, and the rotation of the first mixing blade 160A can mix the material in an expedient, efficient, and effective manner such that the material within the chamber 145 is mixed or substantially mixed (e.g., ±95% mixed) in a shorter amount of time or with greater efficacy than a mixing system that does not include the first mixing blade 160A rotating with the first rotational movement, the second mixing blade 160B rotating with the second rotational movement, and the mixing element 500 rotating with the third rotational movement.

The method 1800 can include removing mixed material at ACT 1835. For example, the method 1800 can include removing mixed material from the chamber 145 at ACT 1835 after the material has been mixed by the first mixing blade 160A, the second mixing blade 160B, or the mixing element 500 at ACTS 1820-1830. The mixed material can be a slurry (e.g., semi-wet or viscous material including solid particulate) or some other material. The chamber 145 can be fluidly coupled with a conduit to remove the material from the chamber 145. For example, the chamber 145 can be fluidly coupled with the conveyance device 190. The conveyance device 190 can be fluidly coupled with the chamber 145 via the aperture 405, the aperture 415, or some other aperture, opening, or valve. The conveyance device 190 can include a vacuum pump or some other mechanism to draw (e.g., pull, suck, evacuate, remove) the material from the chamber 145. The conveyance device 190 can provide the mixed material to some other location for further processing (e.g., production of an electrode). For example, the conveyance device 190 can be fluidly coupled with the chamber 145 and another device (e.g., a slot-die coating system) such that mixed material can be removed from the chamber 145 and provided directly or indirectly to the other device for further processing.

The method 1800 can include applying the material at ACT 1840. For example, the method 1800 can include applying the mixed material to create an electrode (e.g., an anode electrode 2215 or a cathode electrode 2255, as depicted in FIGS. 22-24 and as described below) at ACT 1840. The mixed material can be removed from the chamber 145 at ACT 1835 and provided to another machine, device, or system. For example, the mixed material, such as a slurry created by the material provide at ACT 1805 being mixed by the first mixing blade 160A, the second mixing blade 160B, or the mixing element 500 to create a homogenized or substantially homogenized (e.g., ±greater than 80% homogenized, greater than 90% homogenized, greater than 95% homogenized, greater than 98% homogenized, or some other degree of homogeneity) slurry, can be provided to a slot-die coating system. The slot-die coating system can include at least one cavity to receive the mixed material and at least one coating opening to provide the mixed material onto another surface (e.g., a surface of a current collector material). For example, the slot-die coating system can receive the mixed material and apply (e.g., coat) the mixed material onto another surface via at least one die. The mixed material can be applied to one or more surfaces of a current collector material (e.g., an aluminum or copper foil) to create an electrode. For example, the mixed material can be a slurry (e.g., semi-wet or viscous material) that can be coated on a cooper foil current collector to create an anode electrode or on an aluminum foil to create a cathode electrode. The current collector foil and the applied mixed material can be heated or dried such that the semi-wet or viscous slurry can be cured, dried, or hardened to form an electrode.

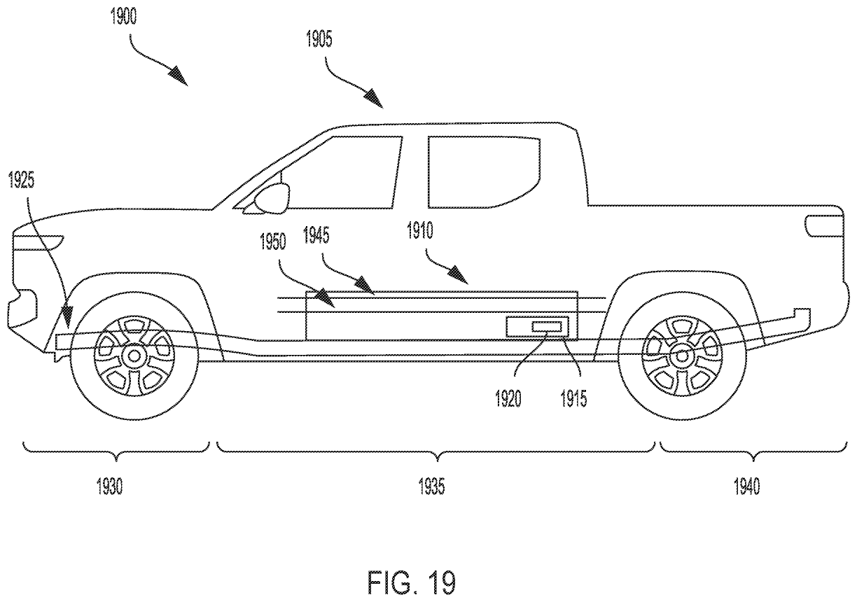

FIG. 19 depicts an example cross-sectional view 1900 of an electric vehicle 1905 installed with at least one battery pack 1910. Electric vehicles 1905 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 1910 can also be used as an energy storage system to power a building, such as a residential home or commercial building. Electric vehicles 1905 can be fully electric or partially electric (e.g., plug-in hybrid) and further, electric vehicles 1905 can be fully autonomous, partially autonomous, or unmanned. Electric vehicles 1905 can also be human operated or non-autonomous. Electric vehicles 1905 such as electric trucks or automobiles can include on-board battery packs 1910, batteries 1915 or battery modules 1915, or battery cells 1920 to power the electric vehicles. The electric vehicle 1905 can include a chassis 1925 (e.g., a frame, internal frame, or support structure). The chassis 1925 can support various components of the electric vehicle 1905. The chassis 1925 can span a front portion 1930 (e.g., a hood or bonnet portion), a body portion 1935, and a rear portion 1940 (e.g., a trunk, payload, or boot portion) of the electric vehicle 1905. The battery pack 1910 can be installed or placed within the electric vehicle 1905. For example, the battery pack 1910 can be installed on the chassis 1925 of the electric vehicle 1905 within one or more of the front portion 1930, the body portion 1935, or the rear portion 1940. The battery pack 1910 can include or connect with at least one busbar, e.g., a current collector element. For example, the first busbar 1945 and the second busbar 1950 can include electrically conductive material to connect or otherwise electrically couple the battery 1915, the battery modules 1915, or the battery cells 1920 with other electrical components of the electric vehicle 1905 to provide electrical power to various systems or components of the electric vehicle 1905.

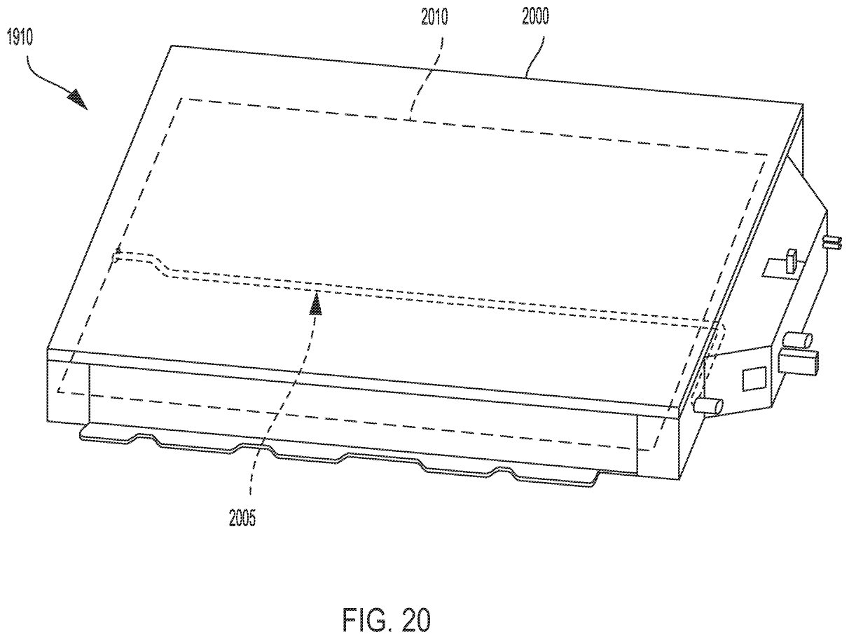

FIG. 20 depicts an example battery pack 1910. Referring to FIG. 20, among others, the battery pack 1910 can provide power to electric vehicle 1905. Battery packs 1910 can include any arrangement or network of electrical, electronic, mechanical or electromechanical devices to power a vehicle of any type, such as the electric vehicle 1905. The battery pack 1910 can include at least one housing 2000. The housing 2000 can include at least one battery module 1915 or at least one battery cell 1920, as well as other battery pack components. The battery module 1915 can be or can include one or more groups of prismatic cells, cylindrical cells, pouch cells, or other form factors of battery cells 1920. The housing 2000 can include a shield on the bottom or underneath the battery module 1915 to protect the battery module 1915 and/or cells 1920 from external conditions, for example if the electric vehicle 1905 is driven over rough terrains (e.g., off-road, trenches, rocks, etc.) The battery pack 1910 can include at least one cooling line 2005 that can distribute fluid through the battery pack 1910 as part of a thermal/temperature control or heat exchange system that can also include at least one thermal component (e.g., cold plate) 2010. The thermal component 2010 can be positioned in relation to a top submodule and a bottom submodule, such as in between the top and bottom submodules, among other possibilities. The battery pack 1910 can include any number of thermal components 2010. For example, there can be one or more thermal components 2010 per battery pack 1910, or per battery module 1915. At least one cooling line 2005 can be coupled with, part of, or independent from the thermal component 2010.

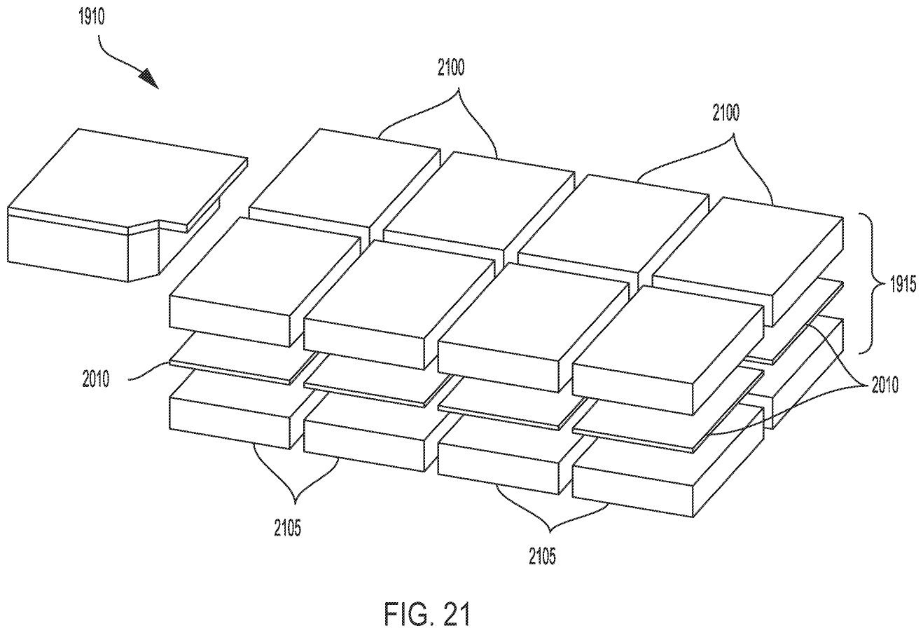

FIG. 21 depicts example battery modules 1915, and FIGS. 22, 23 and 24 depict an example cross sectional view of a battery cell 1920. The battery modules 1915 can include at least one submodule. For example, the battery modules 1915 can include at least one first (e.g., top) submodule 2100 or at least one second (e.g., bottom) submodule 2105. At least one thermal component 2010 can be disposed between the top submodule 2100 and the bottom submodule 2105. For example, one thermal component 2010 can be configured for heat exchange with one battery module 1915. The thermal component 2010 can be disposed or thermally coupled between the top submodule 2100 and the bottom submodule 2105. One thermal component 2010 can also be thermally coupled with more than one battery module 1915 (or more than two submodules 2100, 2105). The thermal components 2010 shown adjacent to each other can be combined into a single thermal component 2010 that spans the size of one or more submodules 2100 or 2105. The thermal component 2010 can be positioned underneath submodule 2100 and over submodule 2105, in between submodules 2100 and 2105, on one or more sides of submodules 2100, 2105, among other possibilities. The thermal component 2010 can be disposed in sidewalls, cross members, structural beams, among various other components of the battery pack, such as battery pack 1910 described above. The battery submodules 2100, 2105 can collectively form one battery module 1915. In some examples each submodule 2100, 2105 can be considered as a complete battery module 1915, rather than a submodule.

The battery modules 1915 can each include a plurality of battery cells 1920. The battery modules 1915 can be disposed within the housing 2000 of the battery pack 1910. The battery modules 1915 can include battery cells 1920 that are cylindrical cells or prismatic cells, for example. The battery module 1915 can operate as a modular unit of battery cells 1920. For example, a battery module 1915 can collect current or electrical power from the battery cells 1920 that are included in the battery module 1915 and can provide the current or electrical power as output from the battery pack 1910. The battery pack 1910 can include any number of battery modules 1915. For example, the battery pack can have one, two, three, four, five, six, seven, eight, nine, ten, eleven, twelve or other number of battery modules 1915 disposed in the housing 2000. It should also be noted that each battery module 1915 may include a top submodule 2100 and a bottom submodule 2105, possibly with a thermal component 2010 in between the top submodule 2100 and the bottom submodule 2105. The battery pack 1910 can include or define a plurality of areas for positioning of the battery module 1915 and/or cells 1920. The battery modules 1915 can be square, rectangular, circular, triangular, symmetrical, or asymmetrical. In some examples, battery modules 1915 may be different shapes, such that some battery modules 1915 are rectangular but other battery modules 1915 are square shaped, among other possibilities. The battery module 1915 can include or define a plurality of slots, holders, or containers for a plurality of battery cells 1920. It should be noted the illustrations and descriptions herein are provided for example purposes and should not be interpreted as limiting. For example, the battery cells 1920 can be inserted in the battery pack 1910 without battery modules 2100 and 2105. The battery cells 1920 can be disposed in the battery pack 1910 in a cell-to-pack configuration without modules 2100 and 2105, among other possibilities.

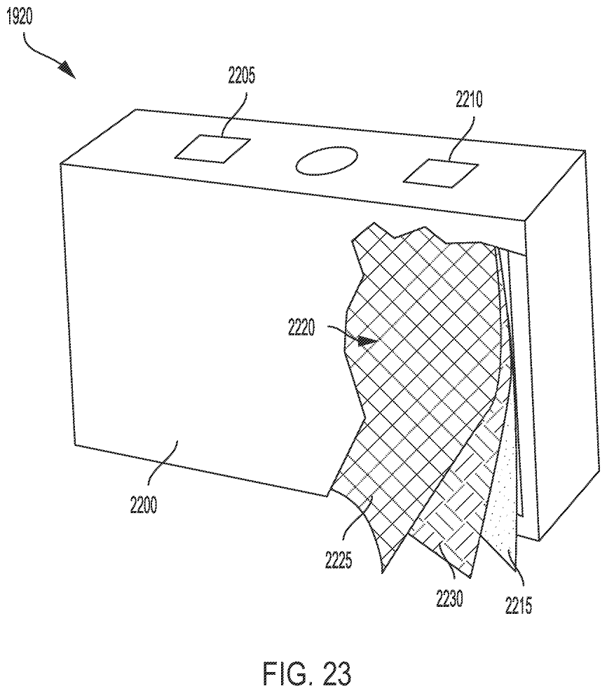

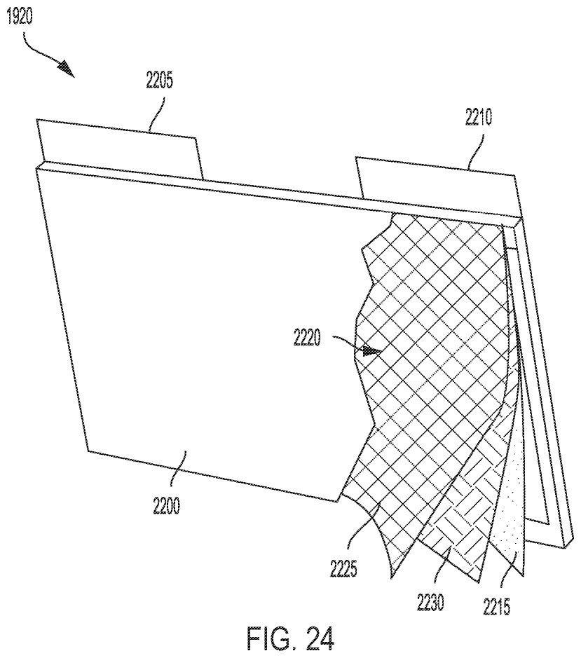

Battery cells 1920 have a variety of form factors, shapes, or sizes. For example, battery cells 1920 can have a cylindrical, rectangular, square, cubic, flat, pouch, elongated or prismatic form factor. As depicted in FIG. 22, for example, the battery cell 1920 can be cylindrical. As depicted in FIG. 23, for example, the battery cell 1920 can be prismatic. As depicted in FIG. 24, for example, the battery cell 1920 can include a pouch form factor. Battery cells 1920 can be assembled, for example, by inserting a winded or stacked electrode roll (e.g., a jelly roll) including electrolyte material into at least one battery cell housing 2200. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 1920 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 1920. The housing 2200 can be of various shapes, including cylindrical or rectangular, for example. Electrical connections can be made between the electrolyte material and components of the battery cell 1920. For example, electrical connections to the electrodes with at least some of the electrolyte material can be formed at two points or areas of the battery cell 1920, for example to form a first polarity terminal 2205 (e.g., a positive or anode terminal) and a second polarity terminal 2210 (e.g., a negative or cathode terminal). The polarity terminals can be made from electrically conductive materials to carry electrical current from the battery cell 1920 to an electrical load, such as a component or system of the electric vehicle 1905.

For example, the battery cell 1920 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 1920 to separate the anode and cathode from each other and to facilitate transfer of lithium ions between the anode and cathode. It should be noted that battery cell 1920 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 1920 can be included in battery modules 1915 or battery packs 1910 to power components of the electric vehicle 1905. The battery cell housing 2200 can be disposed in the battery module 1915, the battery pack 1910, or a battery array installed in the electric vehicle 1905. The housing 2200 can be of any shape, such as cylindrical with a circular (e.g., as depicted in FIG. 22, among others), elliptical, or ovular base, among others. The shape of the housing 2200 can also be prismatic with a polygonal base, as shown in FIG. 23, among others. As shown in FIG. 24, among others, the housing 2200 can include a pouch form factor. The housing 2200 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 2200 of the battery cell 1920 can include one or more materials with various electrical conductivity or thermal conductivity, or a combination thereof. The electrically conductive and thermally conductive material for the housing 2200 of the battery cell 1920 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 2200 of the battery cell 1920 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 2200 of the battery cell 1920 is prismatic (e.g., as depicted in FIG. 23, among others) or cylindrical (e.g., as depicted in FIG. 22, among others), the housing 2200 can include a rigid or semi-rigid material such that the housing 2200 is rigid or semi-rigid (e.g., not easily deformed or manipulated into another shape or form factor). In examples where the housing 2200 includes a pouch form factor (e.g., as depicted in FIG. 24, among others), the housing 2200 can include a flexible, malleable, or non-rigid material such that the housing 2200 can be bent, deformed, manipulated into another form factor or shape.

The battery cell 1920 can include at least one anode layer 2215, which can be disposed within the cavity 2220 defined by the housing 2200. The anode layer 2215 can include a first redox potential. The anode layer 2215 can receive electrical current into the battery cell 1920 and output electrons during the operation of the battery cell 1920 (e.g., charging or discharging of the battery cell 1920). The anode layer 2215 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 1920 can include at least one cathode layer 2225 (e.g., a composite cathode layer compound cathode layer, a compound cathode, a composite cathode, or a cathode). The cathode layer 2225 can include a second redox potential that can be different than the first redox potential of the anode layer 2215. The cathode layer 2225 can be disposed within the cavity 2220. The cathode layer 2225 can output electrical current out from the battery cell 1920 and can receive electrons during the discharging of the battery cell 1920. The cathode layer 2225 can also receive lithium ions during the discharging of the battery cell 1920. Conversely, the cathode layer 2225 can receive electrical current into the battery cell 1920 and can output electrons during the charging of the battery cell 1920. The cathode layer 2225 can release lithium ions during the charging of the battery cell 1920.

The battery cell 1920 can include an electrolyte layer 2230 disposed within the cavity 2220. The electrolyte layer 2230 can be arranged between the anode layer 2215 and the cathode layer 2225 to separate the anode layer 2215 and the cathode layer 2225. A separator can be wetted with a liquid electrolyte. The liquid electrolyte can be diffused into the anode layer 2215. The liquid electrolyte can be diffused into the cathode layer 2225. The electrolyte layer 2230 can help transfer ions between the anode layer 2215 and the cathode layer 2225. The electrolyte layer 2230 can transfer Li⁺ cations from the anode layer 2215 to the cathode layer 2225 during the discharge operation of the battery cell 1920. The electrolyte layer 2230 can transfer lithium ions from the cathode layer 2225 to the anode layer 2215 during the charge operation of the battery cell 1920.

The redox potential of layers (e.g., the first redox potential of the anode layer 2215 or the second redox potential of the cathode layer 2225) can vary based on a chemistry of the respective layer or a chemistry of the battery cell 1920. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 2225). Lithium-ion batteries can include a graphite chemistry, a silicon-graphite chemistry, or a lithium metal chemistry for the anode layer (e.g., the anode layer 2215).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example lithium iron phosphate (LFP), lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 2225). Lithium-ion batteries can include a graphite chemistry, a silicon-graphite chemistry, or a lithium metal chemistry for the anode layer (e.g., the anode layer 2215). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 2225) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 2215) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 2230 can include or be made of a liquid electrolyte material. For example, the electrolyte layer 2230 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 2230 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 2230 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (Li_{X}PO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 2230 includes a liquid electrolyte material, the electrolyte layer 2230 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 2230 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 2230 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 2230 from greater than 0 M to about 1.5 M.

FIG. 25 depicts an example block diagram of an example computer system 2500. The computer system or computing device 2500 can include or be used to implement a data processing system or its components. The computing system 2500 includes at least one bus 2505 or other communication component for communicating information and at least one processor 2510 or processing circuit coupled to the bus 2505 for processing information. The computing system 2500 can also include one or more processors 2510 or processing circuits coupled to the bus for processing information. The computing system 2500 also includes at least one main memory 2515, such as a random access memory (RAM) or other dynamic storage device, coupled to the bus 2505 for storing information, and instructions to be executed by the processor 2510. The main memory 2515 can be used for storing information during execution of instructions by the processor 2510. The computing system 2500 may further include at least one read only memory (ROM) 2520 or other static storage device coupled to the bus 2505 for storing static information and instructions for the processor 2510. A storage device 2525, such as a solid state device, magnetic disk or optical disk, can be coupled to the bus 2505 to persistently store information and instructions.

The computing system 2500 may be coupled via the bus 2505 to a display 2535, such as a liquid crystal display, or active matrix display, for displaying information to a user such as a driver of the electric vehicle 1905 or other end user. An input device 2530, such as a keyboard or voice interface may be coupled to the bus 2505 for communicating information and commands to the processor 2510. The input device 2530 can include a touch screen display 2535. The input device 2530 can also include a cursor control, such as a mouse, a trackball, or cursor direction keys, for communicating direction information and command selections to the processor 2510 and for controlling cursor movement on the display 2535.

The processes, systems and methods described herein can be implemented by the computing system 2500 in response to the processor 2510 executing an arrangement of instructions contained in main memory 2515. Such instructions can be read into main memory 2515 from another computer-readable medium, such as the storage device 2525. Execution of the arrangement of instructions contained in main memory 2515 causes the computing system 2500 to perform the illustrative processes described herein. One or more processors in a multi-processing arrangement may also be employed to execute the instructions contained in main memory 2515. Hard-wired circuitry can be used in place of or in combination with software instructions together with the systems and methods described herein. Systems and methods described herein are not limited to any specific combination of hardware circuitry and software.

Although an example computing system has been described in FIG. 25, the subject matter including the operations described in this specification can be implemented in other types of digital electronic circuitry, or in computer software, firmware, or hardware, including the structures disclosed in this specification and their structural equivalents, or in combinations of one or more of them.

FIG. 16, among others, is a flow chart of a method 2600 of providing a mixing system. For example, the method 2600 can include providing the mixing system 100 as discussed herein at ACT 2605. The mixing system 100 can mix (e.g., blend, disperse, knead, homogenize, dilute, or otherwise mix) a material, such as an electrode material. The mixing system 100 can mix a material more efficiently (e.g., in a shorter amount of time) and with greater efficacy (e.g., achieving a higher degree of homogeneity) than conventional mixing systems. The mixing system 100 can include a mixer stand 105 having a top portion 110, a body portion 115, and a bottom portion 120. The mixing system 100 can include a mixer vessel 135 defining a chamber 145. The mixer vessel 135 can include an outer vessel 140. The mixer vessel 135 can include an inner vessel 150. For example, the inner vessel 150 can be positioned within the outer vessel 140 and can rotate within the outer vessel 140. The inner vessel 150 can define the chamber 145. The mixing system 100 can include at least one mixing blade 160 and at least one mixing element 500. For example, the mixing system 100 can include the first mixing blade 160A to rotate with the first rotational movement, the second mixing blade 160B to rotate with the second rotational movement, and the mixing element 500 to rotate with the third rotational movement. The mixing element 500 can be or include a baffle 505 to rotate within the chamber 145, where the baffle 505 can move along a circular path within the chamber 145 to mix the material. The mixing element 500 can be or include the inner vessel 150. For example, the inner vessel 150 can rotate within the outer vessel 140 to mix the material. The mixing system 100 can include a thermal element 175, a vacuum device 180, or a computing system 185. The first rotational movement of the first mixing blade 160A, the second rotational movement of the second mixing blade 160B, and the third rotational movement of the mixing element 500 can create at least one high shear mixing zone 520, at least one medium shear mixing zone 525, and at least one low shear mixing zone 530 to mix the material within the chamber. Each of the first mixing blade 160A, the second mixing blade 160B, and the mixing element 500 can be independently operated or controlled. For example, the first rotational movement of the first mixing blade 160A, the second rotational movement of the second mixing blade 160B, and the third rotational movement of the mixing element 500 can be independent.

FIG. 27, among others, is a flow chart of a method 2700 of providing an electrode. For example, the method 2700 can include providing an electrode at ACT 2705, where the electrode can be produced by the mixing system 100 described herein. The electrode can be an anode electrode (e.g., the anode electrode 2215) or a cathode electrode (e.g., the cathode electrode 2225). The electrode can include an electrode material (e.g., a cathode electrode material or an anode electrode material) that has been applied to a current collector material, such as a copper foil or an aluminum foil. The electrode material can be applied the current collector material as a slurry. For example, the electrode material can be a slurry (e.g., a semi-wet, viscous, or semi-dry material). The electrode material can be applied the current collector material via a slot-die coating machine or some other device to apply the slurry to the current collector foil. The electrode material can be created by mixing multiple materials or ingredients. For example, materials (e.g., solid materials, liquid materials, or other materials) can be mixed in the mixing system 100 to create a homogenized or substantially homogenized (e.g., ±greater than 80% homogenized, greater than 90% homogenized, greater than 95% homogenized, greater than 98% homogenized, or some other degree of homogeneity) mixed material from multiple materials or ingredients. The mixing system 100 can include the first mixing blade 160A to rotate with the first rotational movement, the second mixing blade 160B to rotate with the second rotational movement, and the mixing element 500 to rotate with the third rotational movement, where the first rotational movement is independent from at least one of the second rotational movement or the third rotational movement.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a mixer vessel that defines a chamber;
a first mixing blade to cause a first rotational movement to mix a material within the chamber;
a second mixing blade to cause a second rotational movement to mix the material within the chamber of the mixer vessel;
a mixing element to cause a third rotational movement to mix the material within the chamber of the mixer vessel; and
the first mixing blade to cause the first rotational movement independent from at least one of the second rotational movement and the third rotational movement.

2. The system of claim 1, comprising:
the mixer vessel including a stationary outer vessel;
the mixing element including an inner vessel, the inner vessel positioned within the stationary outer vessel of the mixer vessel to define the chamber; and
the inner vessel to rotate relative to the stationary outer vessel to mix the material within the chamber.

3. The system of claim 1, comprising:
the mixer vessel including a stationary outer vessel;
the mixing element including an inner vessel, the inner vessel positioned within the stationary outer vessel of the mixer vessel to define the chamber;
the first mixing blade to rotate in a first direction with the first rotational movement;
the second mixing blade to rotate in a second direction with the second rotational movement, the second direction being opposite the first direction; and
the inner vessel to rotate in either the first direction or the second direction relative to the stationary outer vessel with the third rotational movement.

4. The system of claim 1, comprising:
the mixer vessel including a stationary outer vessel;
the mixing element including an inner vessel, the inner vessel positioned within the stationary outer vessel of the mixer vessel to define the chamber;
the first mixing blade to rotate at a first speed with the first rotational movement;
the second mixing blade to rotate at a second speed with the second rotational movement, the second speed being different than the first speed; and
the inner vessel to rotate relative to the stationary outer vessel at a third speed with the third rotational movement.

5. The system of claim 1, comprising:
the mixer vessel including a stationary outer vessel;
the mixing element including an inner vessel, the inner vessel positioned within the stationary outer vessel of the mixer vessel to define the chamber;
the first mixing blade to rotate in a first direction with the first rotational movement;
the inner vessel to rotate in a second direction relative to the stationary outer vessel with the third rotational movement, the second direction being opposite the first direction; and
the first rotational movement of the first mixing blade and the third rotational movement of the inner vessel to create a high shear mixing zone between the first mixing blade and the inner vessel to mix the material.

6. The system of claim 1, comprising:
the first mixing blade to rotate in a first direction with the first rotational movement;
the second mixing blade to rotate in a second direction with the second rotational movement, the second direction being opposite the first direction; and
the first rotational movement of the first mixing blade and the second rotational movement of the second mixing blade to create a high shear mixing zone between the first mixing blade and the second mixing blade to mix the material.

7. The system of claim 1, comprising:
the first mixing blade to rotate in a first direction at a first speed with the first rotational movement;
the second mixing blade to rotate in a second direction and a second speed with the second rotational movement, the second speed being different than the first speed and the second direction being different than the first direction; and
the first rotational movement of the first mixing blade and the second rotational movement of the second mixing blade to create a high shear mixing zone between the first mixing blade and the second mixing blade to mix the material.

8. The system of claim 1, comprising:
the mixing element including a first baffle and a second baffle, the first baffle extending into the chamber and moving within the chamber with the third rotational movement to mix the material, and the second baffle extending into the chamber and moving within the chamber with a fourth rotational movement to mix the material.

9. The system of claim 1, comprising:
the mixer vessel including an inner wall;
the first rotational movement of the first mixing blade and the second rotational movement of the second mixing blade to create a high shear mixing zone between the first mixing blade and the second mixing blade;
the first rotational movement of the first mixing blade and the third rotational movement of the mixing element to create a second high shear mixing zone between the first mixing blade and the mixing element;
the second rotational movement of the second mixing blade and the third rotational movement of the mixing element to create a medium shear mixing zone between the second mixing blade and the mixing element; and
the third rotational movement of the mixing element to create a low shear mixing zone between the inner wall and the mixing element.

10. The system of claim 1, comprising:
the first mixing blade to rotate in a first direction with the first rotational movement;
the second mixing blade to rotate in a second direction with the second rotational movement the second direction being opposite the first direction; and
the mixing element including a baffle extending into the chamber and moving in either the first direction or the second direction within the chamber with the third rotational movement to mix the material.

11. The system of claim 1, comprising:
the first mixing blade to rotate in a first direction and at a first speed with the first rotational movement;
the second mixing blade to rotate in a second direction and at a second speed with the second rotational movement, the second direction being different than the first direction and the second speed being different than the first speed; and
the mixing element including a baffle extending into the chamber and moving in the first direction or the second direction and at a third speed within the chamber with the third rotational movement to mix the material.

12. The system of claim 1, comprising:
a gearbox coupled with the first mixing blade and the second mixing blade, the gearbox to cause the first mixing blade to rotate with the first rotational movement and the second mixing blade to rotate with the second rotational movement; and
a hood positioned around at least a portion of the first mixing blade and the second mixing blade with the first mixing blade and the second mixing blade extending into the chamber.

13. The system of claim 1, comprising:
the first mixing blade including a first blade geometry; and
the second mixing blade including a second blade geometry, the second blade geometry being different than the first blade geometry.

14. The system of claim 1, comprising:
the mixer vessel including a thermal element, the thermal element to provide thermal energy to the chamber to alter a temperature of the material.

15. A method, comprising:
adding a material to a chamber of a mixer vessel;
rotating a first mixing blade extending into the chamber of the mixer vessel for mixing the material within the chamber;
rotating a second mixing blade extending into the chamber of the mixer vessel for mixing the material within the chamber; and
rotating a mixing element for mixing the material within the chamber, a first rotational movement of the first mixing blade independent from at least one of a second rotational movement of the second mixing blade and a third rotational movement of the mixing element.

16. The method of claim 15, comprising:
rotating the first mixing blade in a first direction with the first rotational movement; and
rotating the second mixing blade in a second direction with the second rotational movement, the second direction opposite the first direction for creating a high shear mixing zone between the first mixing blade and the second mixing blade within the chamber.

17. The method of claim 15, comprising:
rotating the first mixing blade in a first direction with the first rotational movement; and
rotating the mixing element in a second direction with the third rotational movement, the second direction opposite the first direction for creating a high shear mixing zone between the first mixing blade and the mixing element within the chamber.

18. The method of claim 15, wherein the mixer vessel includes a stationary outer vessel and the mixing element includes an inner vessel, the inner vessel positioned within the stationary outer vessel of the mixer vessel to define the chamber;
rotating the first mixing blade in a first direction with the first rotational movement; and
rotating the inner vessel within the stationary outer vessel in a second direction with the second rotational movement, the second direction opposite the first direction for creating a high shear mixing zone between the first mixing blade and the inner vessel.

19. A method of manufacturing an electrode, comprising:
adding an electrode material to a chamber of a mixer vessel;
rotating a first mixing blade extending into the chamber of the mixer vessel for mixing the electrode material within the chamber;
rotating a second mixing blade extending into the chamber of the mixer vessel for mixing the electrode material within the chamber; and
rotating a mixing element for mixing the electrode material within the chamber, a first rotational movement of the first mixing blade independent from at least one of a second rotational movement of the second mixing blade and a third rotational movement of the mixing element; and
applying the mixed electrode material to a current collector material.

20. The method of claim 19, comprising:
rotating the first mixing blade in a first direction with the first rotational movement; and
rotating the second mixing blade in a second direction with the second rotational movement, the second direction opposite the first direction for creating a high shear mixing zone between the first mixing blade and the second mixing blade within the chamber.
